(19) United States
(12) Patent Application Publication
(10) Pub. No.: US 2023/0388412 A1
(43) Pub. Date: Nov. 30, 2023

(54) REPUTATION MANAGEMENT PLATFORM AND METHODS THEREOF

(71) Applicant: Somos, Inc., East Brunswick, NJ (US)

(72) Inventors: David Alexander Stewart, Vienna, VA (US); Shreerang Anil Shastri, Reading, MA (US); Naveen Jayachandran, Herndon, VA (US)

(21) Appl. No.: 18/323,895

(22) Filed: May 25, 2023

Related U.S. Application Data
(60) Provisional application No. 63/346,444, filed on May 27, 2022.
(60) Provisional application No. 63/453,586, filed on Mar. 21, 2023.

(51) Int. Cl. H04M 3/42

(52) U.S. Cl. CPC H04M 3/42068; H04M 3/4228; H04M 2203/6027

(57) ABSTRACT

A system for assigning reputation scores is provided. The system includes a first database, a second database, and a registrar server. The first database stores first data corresponding to at least one telecommunications identifier. The second database stores second data corresponding to the at least one telecommunications identifier. The registrar server is structured to: access and interpret the first data and the second data to determine one or more attributes for the at least one telecommunications identifier; determine a reputation score for the at least one telecommunications identifier; and transmit the reputation score.

### CROSS-REFERENCE TO RELATED APPLICATIONS

This application claims the benefit of and priority to: U.S. Provisional Patent Application Ser. No. 63/346,444, filed May 27, 2022, and entitled “REPUTATION MANAGEMENT PLATFORM AND METHODS THEREOF” (SMS8-0011-P01); and U.S. Provisional Patent Application Ser. No. 63/453,586, filed Mar. 21, 2023, and entitled “REPUTATION MANAGEMENT PLATFORM AND METHODS THEREOF” (SMS8-0011-P02).

All of the foregoing patents and patent applications are incorporated herein by reference in their entirety for all purposes.

### FIELD OF INVENTION

This disclosure is related to the determination and management of reputations for telecommunications identifiers and/or entities.

### BACKGROUND

The amount of fraudulent telecommunications is increasing as the number of mobile devices and/or internet users increases. Fraudulent telecommunications are often considered to be a nuisance and/or a waste of telecommunication infrastructure/resources. In an attempt to mitigate telecommunications fraud, deny lists are often used to block entities known to be “bad actors” from accessing telecommunication resources. Unscrupulous entities, however, have been able to circumvent such deny lists by using shell entities, which they open and use to commit fraudulent acts until the shell entities have been added to a deny list, after which the unscrupulous entities open new shell entities, thereby repeating the same process. Such unscrupulous entities, however, often use the same network identifiers, e.g., phone numbers, from which they originate fraudulent telecommunication traffic and/or use telecommunications identifiers that were previously associated with legitimate (trustworthy) entities but which have been dropped from use, e.g., the legitimate entity no longer exists but the telecommunications identifier remains available for use.

Campaign messaging has become an efficient and valuable mechanism for entities to reach large numbers of members, subscribers, and/or customers. Presently, many campaign messaging systems are unable to provide trust mechanisms. As a result, unscrupulous entities often exploit campaign messaging systems to SPAM large numbers of recipients, thus eroding trust in the campaign messaging system and/or legitimate entities whose identities may be spoofed by bad actors launching fraudulent messaging campaigns.

### SUMMARY

Embodiments of the current disclosure provide for an apparatus for assigning reputation scores to telecommunications identifiers. The apparatus includes a first data interpretation circuit, a second data interpretation circuit, a data analysis circuit, a scoring circuit, and a score provisioning circuit. The first data interpretation circuit is structured to interpret first data from a first database, wherein the first data corresponds to at least one telecommunications identifier. The second data interpretation circuit is structured to interpret second data from a second database distinct from the first database, wherein the second data corresponds to the at least one telecommunications identifier. The data analysis circuit is structured to determine, based at least in part on the first data and the second data, one or more attributes for the at least one telecommunications identifier. The scoring circuit is structured to generate, based at least in part on the one or more attributes, a reputation score for the at least one telecommunications identifier. The score provisioning circuit is structured to transmit the reputation score.

Embodiments of the current disclosure provide for a method for assigning scores to telecommunications identifiers. The method includes interpreting, via at least one processor, first data from a first database, the first data corresponding to at least one telecommunications identifier; and interpreting, via the at least one processor, second data from a second database, the second data corresponding to the at least one telecommunications identifier. The method further includes determining, via the at least one processor and based at least in part on the first data and the second data, one or more attributes for the at least one telecommunications identifier; and generating, via the at least one processor and based at least in part on the one or more attributes, a reputation score for the at least one telecommunications identifier. The method further includes transmitting, via the at least one processor, the reputation score.

Embodiments of the current disclosure provide for a method that includes interpreting call routing data with a telecommunications identifier; and generating, via at least one processor, a reputation score request command value structured to retrieve a reputation score for a telecommunications identifier. The method further includes transmitting the reputation score request command value to a server; and receiving a reputation score responsive to transmitting the reputation score request command value to the server, the reputation score corresponding to the telecommunications identifier. The method further includes executing an action with respect to the call routing data based at least in part on the reputation score.

Embodiments of the current disclosure provide for a method that includes generating, via a campaign requesting circuit, a messaging campaign request that includes a request to execute a messaging campaign; and transmitting, via a campaign request provisioning circuit, the messaging campaign request to an approving authority. The method further includes interpreting, via an approval processing circuit, a campaign approval message from the approving authority; and transmitting, via a campaign circuit and based at least in part on the campaign approval message, a plurality of electronic communications in accordance with the messaging campaign.

Embodiments of the current disclosure provide for an apparatus that includes a campaign requesting circuit, a campaign request provisioning circuit, an approval processing circuit, and a campaign circuit. The campaign requesting circuit is structured to generate a messaging campaign request that includes a request to execute a messaging campaign. The campaign request provisioning circuit is structured to transmit the messaging campaign request to an approving authority. The approval processing circuit is structured to interpret a campaign message from the approving authority. The campaign circuit is structured to transmit a plurality of electronic communications in accordance with the messaging campaign.

Embodiments of the current disclosure provide for a method for executing a messaging campaign. The method includes generating a plurality of telecommunication messages; and transmitting each of the plurality of telecommunication messages to one of a plurality of telecommunications identifiers each associated with an intended distinct recipient. Each of the plurality of telecommunication messages is associated with a same telecommunication identifier (also referred to herein as a telecommunications identifier), e.g., a local number, toll-free number (TFN), and/or short code.

Embodiments of the current disclosure provide for a method for executing a messaging campaign. The method includes generating a plurality of telecommunication messages; and transmitting each of the plurality of telecommunication messages to one of a plurality of telecommunications identifiers each associated with an intended distinct recipient. Each of the plurality of telecommunication messages is associated with a same ten-digit code.

Certain further aspects of example systems, apparatuses, and methods are described following, any one or more of which may be present in certain embodiments of the current disclosure.

### BRIEF DESCRIPTION OF THE FIGURES

FIG. 1 is a diagram of a system for assigning reputation scores and/or for providing trusted campaign messaging, in accordance with embodiments of the current disclosure;

FIG. 2 is a block diagram of a campaign message, in accordance with embodiments of the current disclosure;

FIG. 3 is a block diagram of a campaign message request, in accordance with embodiments of the current disclosure;

FIG. 4 is a block diagram of an approval message, in accordance with embodiments of the current disclosure;

FIG. 5 is a diagram of a registrar, in accordance with embodiments of the current disclosure;

FIG. 6 is a schematic diagram of an apparatus for approving a campaign message request, in accordance with embodiments of the current disclosure;

FIG. 7 is a flowchart for a method for approving a campaign message request, in accordance with embodiments of the current disclosure;

FIG. 8 is a schematic diagram of an apparatus for conducting a trusted messaging campaign, in accordance with embodiments of the current disclosure;

FIG. 9 is a flowchart depicting a method for conducting a trusted messaging campaign, in accordance with embodiments of the current disclosure;

FIG. 10 is a flowchart depicting a method for executing a messaging campaign, in accordance with embodiments of the current disclosure;

FIG. 11 is a flowchart depicting another method for executing a messaging campaign, in accordance with embodiments of the current disclosure;

FIG. 12 is a block diagram of a reputation request, in accordance with embodiments of the current disclosure;

FIG. 13 is a schematic diagram of an apparatus for assigning reputation scores to telecommunications identifiers, in accordance with embodiments of the current disclosure;

FIG. 14 is a flowchart depicting a method for assigning reputation scores to telecommunications identifiers, in accordance with embodiments of the current disclosure;

FIG. 15 is a diagram of attributes, and groups thereof, for telecommunications identifiers and/or entities, in accordance with embodiments of the current disclosure;

FIG. 16 is a block diagram of components and procedures for determining attributes, and groups thereof, for telecommunications identifiers and/or entities, in accordance with embodiments of the current disclosure;

FIG. 17 is a process flow diagram for executing a trusted messaging campaign, in accordance with embodiments of the current disclosure;

FIG. 18 is a diagram of an application programming interface (API), in accordance with embodiments of the current disclosure;

FIG. 19 is a chart depicting results of aggregate TFN experiments, in accordance with embodiments of the current disclosure;

FIG. 20 is another chart depicting results of aggregate TFN experiments, in accordance with embodiments of the current disclosure;

FIG. 21 is another chart depicting results of aggregate TFN experiments, in accordance with embodiments of the current disclosure;

FIG. 22 is another chart depicting results of aggregate TFN experiments, in accordance with embodiments of the current disclosure;

FIG. 23 is another chart depicting results of aggregate TFN experiments, in accordance with embodiments of the current disclosure;

FIG. 24 is another chart depicting results of aggregate TFN experiments, in accordance with embodiments of the current disclosure;

FIG. 25 is another chart depicting results of aggregate TFN experiments, in accordance with embodiments of the current disclosure;

FIG. 26 is another chart depicting results of aggregate TFN experiments, in accordance with embodiments of the current disclosure;

FIG. 27 is another chart depicting results of aggregate TFN experiments, in accordance with embodiments of the current disclosure;

FIG. 28 is another chart depicting results of aggregate TFN experiments, in accordance with embodiments of the current disclosure;

FIG. 29 is a diagram of a graphical user interface (GUI), in accordance with embodiments of the current disclosure;

FIG. 30 is a diagram of another GUI, in accordance with embodiments of the current disclosure;

FIG. 31 is a diagram of another GUI, in accordance with embodiments of the current disclosure;

FIG. 32 is a diagram of another GUI, in accordance with embodiments of the current disclosure; and

FIG. 33 is a diagram of another GUI, in accordance with embodiments of the current disclosure.

### DETAILED DESCRIPTION

Embodiments of the current disclosure may provide for reputational scores (also referred to herein as a reputation score or simply reputation), and/or methods of determining reputation scores, for telecommunications identifiers, e.g., local phone numbers, VOIP numbers, TFNs, usernames, and/or any other type of communications identifier that indicates if the telecommunications identifier is associated with fraud or is trustworthy. Provisioning of a reputational score, as disclosed herein, for a telecommunications identifier may allow entities involved in routing telecommunications data, e.g., traffic, to better detect fraudulent activities and/or to better distinguish between authorized telecommunications data and fraudulent telecommunications data. For example, certain embodiments of the current disclosure may improve the ability of telecommunication carriers and/or network operators to take action against fraudulent telecommunications data while minimizing negative impacts to authorized telecommunications traffic.

Embodiments of the current disclosure may also improve trust between entities involved in generating telecommunications traffic and entities involved in transporting and/or delivering the telecommunications traffic to an end point. For example, embodiments of the current disclosure may provide for trusted messaging campaigns over short codes, ten-(10)-digit numbers, and/or any other type of telecommunication numbers. As will be understood, a benefit of providing trusted messaging campaigns via a ten-(10)-digit code is that a receiving party of such a campaign message may easily call the number from which the campaign message was sent. Embodiments of the current disclosure may require that a campaign be approved to use a certain telecommunications number before sending messages from the number.

Embodiments of the current disclosure also provide for group reputation scores, which may be an aggregate value corresponding to the reputation of two or more telecommunications identifiers.

Embodiments of the current disclosure may also provide for messaging platform providers and/or RespOrgs to better regulate telecommunications traffic originating from messaging platforms and/or telecommunication identifiers (e.g., TFNs, Internet Protocol (IP) addresses, media access control (MAC) addresses, usernames, etc.) and transmitted to network operators, e.g., mobile network operators such as cellular communications networks.

As disclosed in greater detail herein, embodiments of the current disclosure provide for trusted Application-to-Person (A2P) messaging based on reputation scores. The reputation scores may be structured to quantify a TFN's risk based on its historical ownership, application, and/or fraud history. The reputation scores may be derived from and/or based on combining first party operational data from registries, e.g., TFN and/or Toll-Free Texting and Smart Services (TSS), with industry insights.

As used herein, a campaign, also referred to herein as a messaging campaign, may include sending one or more telecommunications messages to one or more telecommunication numbers, e.g., sending a marketing text via short message/messaging service (SMS), email, etc. and/or a voice message to thousands of consumers.

Embodiments of the current disclosure may use raw operational data from telecommunication registries to generate reputational attributes which, in turn, may be used to generate reputation scores for telecommunications identifiers that allow entities involved in generating, transporting (routing and/or switching), and/or receiving telecommunication data associated with the telecommunications identifiers to make better/improved decisions and/or to take actions based on the reputation scores, e.g., dropping telecommunications traffic associated with untrustworthy telecommunications identifiers while permitting telecommunications traffic associated with trustworthy telecommunications identifiers. As will be appreciated, in embodiments, a TFN reputation score, as disclosed herein, may act/serve as a lead indicator of fraud and/or campaign performance. Accordingly, some embodiments of the current disclosure provide for trusted information to drive global connections, e.g., worldwide communications, which, in turn, may provide for organizations to innovate and grow with confidence. The reputation scores, as disclosed herein, may also improve trust relationships between consumers and brands as consumers (and/or communities) can have improved confidence that received campaign messages are, in fact, from who they purport to be from and/or that the entity behind the messaging campaign is a trustable entity. Thus, some embodiments of the current disclosure provide for improved security and/or reliability, and/or may empower customers to make better informed decisions.

As used herein, a TFN Registry, also referred to herein as a “TFNR”, may include databases related to the North American Numbering and Identify Administration. The TFN registry may include more than 43.5 M toll-free numbers supporting over 1,400 service providers. Embodiments of the TFN Registry may contain records corresponding to 1.8B identities.

Embodiments of the current disclosure may provide for an improved business messaging ecosystem by adding a neutral and transparent rating/scoring entity that builds upon trusted A2P delivery solutions without unnecessary friction and costs. As such, embodiments of the current disclosure may provide for businesses to grow at an aggressive pace. Embodiments of the current disclosure may also improve the ability of mobile network operators (MNOs) to sift through and better handle gray traffic, which may be on the order of billions of messages per month. For example, embodiments may convert onto A2P channels, e.g., sms messages may be moved to a dedicated MNO network channel and/or a dedicated network connection. Embodiments of the current disclosure may also provide for competition in the messaging transit space. Embodiments of the current disclosure may also elevate valid users with trusted, neutral transparency.

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

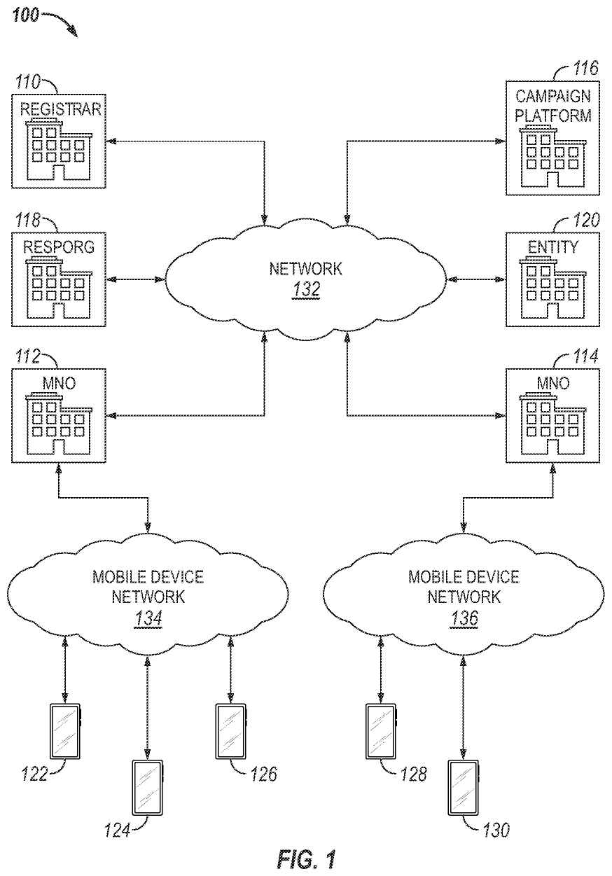

Accordingly, referencing FIG. 1, an example system 100 for assigning reputation scores and/or for providing trusted campaign messaging includes a registrar 110, one or more mobile network operators (MNOs) 112 and 114, a campaign messaging system/platform/provider 116, a responsible organization (RespOrg) 118, and/or an entity 120 seeking to use a messaging campaign to reach mobile device users 122, 124, 126, 128, 130, a network, e.g., the Internet, 132, and/or one or more mobile device networks 134 and 136. While FIG. 1 depicts the system 100 as including all of the foregoing elements, it is to be understood that embodiments of the system 100 may include fewer or more elements. For example, in embodiments, the system 100 may include the registrar 110, and/or the one or more MNOs 112, 114. In embodiments, the system 100 may include the registrar 110 and/or the RespOrg 118. In embodiments, the system 100 may include the registrar 110, the RespOrg 118, and the MNOs 112, 114. In embodiments, the system 100 may include the registrar 110 and the campaign platform 116. In embodiments, the system 100 may include the registrar 110, the campaign platform 116, and the RespOrg 118. In embodiments, the system 100 may include the registrar 110, the campaign platform 116 and the one or more MNOs 112, 114. In embodiments, entities 120 seeking to use a messaging campaign may include global A2P customers such as multifactor authentication providers, call centers, health services, enterprises, etc. Additionally, it is to be understood that the mobile device users 122, 124, 126, 128, and/or 130 may be users of any type of electronic computing device, to include non-mobile devices, e.g., desktop computers, stationary telephones, and/or other devices that can display and/or play a message to a user.

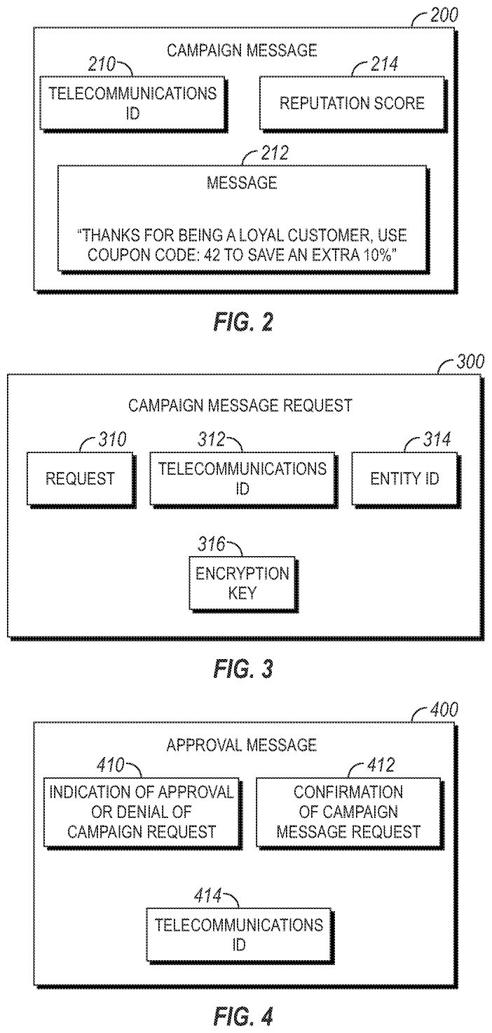

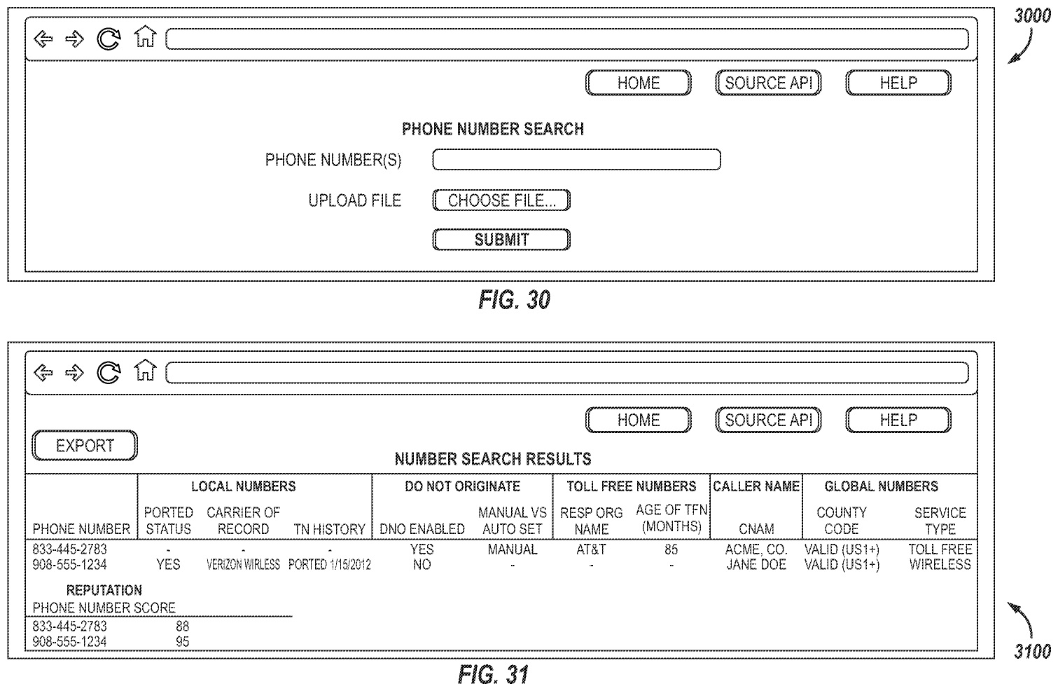

As will be explained in greater detail herein, the entity 120 may desire to send trusted campaign messages 200 (FIG. 2) to the mobile device users 122, 124, 126, 128, 130. Accordingly, the entity 120 may use the campaign platform 116 to generate a campaign message/messaging request 300 (FIG. 30) (also referred to herein as a messaging campaign request and/or a campaign messaging request) that includes a request 310 to execute a messaging campaign. Generation of the campaign message request 300 may be performed by the entity 120 and/or by an entity operating the campaign platform 116.

The campaign message request 300 is then transmitted to an approving authority which, in embodiments, may be the registrar 110 and/or the campaign platform 116. The approving authority may then transmit an approval message 400 (FIG. 4), which may approve or deny the campaign message request 300. The campaign platform 116 may then interpret the approval message 400 and, if the entity is authorized/approved, proceed to transmit a plurality of electronic communications, e.g., campaign messages 200 (FIG. 2), in accordance with the messaging campaign. In embodiments, real-time telecommunications traffic may be used to enhance a reputation score.

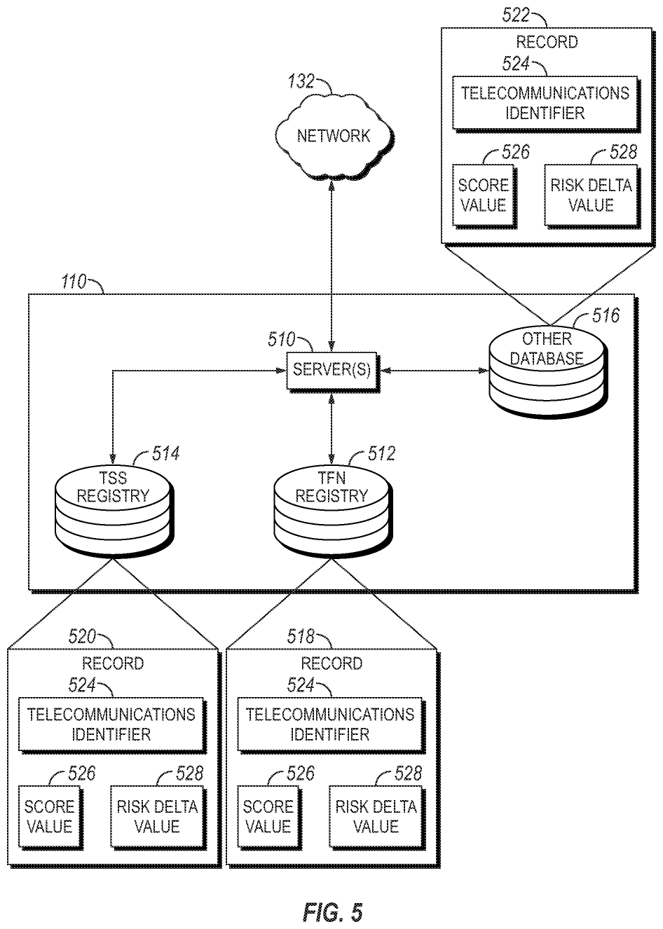

As will be understood, embodiments of the registrar 110 may be in an optimal position within a telecommunications network to act as the approval authority due to the registrar's role as a neutral steward of the TFN 512 and/or TSS 514 (FIG. 5) databases/registries which, in turn, provides for entities (e.g., telecommunication carriers, SMS campaign operators and/or platforms, Responsible Organizations, IVR/Call centers, etc.) to transact and/or communicate with confidence. Certain aspects of the current disclosure may provide for telephone numbers (TN)s and/or TFNs for text enablement for RealNumber Right to Use (RTU) verification through TSS, e.g., an A2P provisioning verification engine via a TSS registry. In embodiments, the registrar 110 may be an authoritative source and/or administrator of 2.5 M TFN identities CNAM records, 5.85 M test enabled TFNs, 28 M auto set TND DNOs, 800K RespOrg set DNOs, and/or 4B+local DNOs. In embodiments, the registrar 110 may provide Trusted Number Information Services (NIS) from various countries and MNOs, messaging companies, and/or financial services companies across the various countries. As will be understood, such offerings may provide for voice and/or message routing, fraud protections and/or identify/validation services. Non-limiting examples of NIS messaging offerings include network routing intelligence, least cost routing information, and/or ensuring termination to actual end users. Non-limiting examples of NIS identify validation and fraud protection offerings include number/subscriber information, and/or authenticated numbers and subscriber data. Customers of NIS may include A2P, Over-the-Top (OTT) messaging providers, and/or marketing and financial service companies.

As illustrated in FIG. 2, a campaign message 200 may include a telecommunications identifier 210, a message 212, a reputation score 214 for the entity 120 (FIG. 1), and/or additional data relevant to the entity 120. In embodiments, the telecommunications identifier 210 may be a short code and/or a ten-digit code. As will be appreciated, use of short codes and/or ten-digit codes provides for mobile device users to easily contact and/or respond back to an entity 120 (FIG. 1) that launches a messaging campaign. In embodiments, the telecommunications identifier (ID) 210 may be a telecommunications number, e.g., a phone number such as a local number or a toll-free number. In embodiments, the telecommunications identifier 210 may include and/or be: an IP address; a MAC address; a local telephone number (also referred to herein as a local number); a TFN; an internet of things (IoT) device identifier; a street address, a mailing address; a textual name, e.g., an individual's name, a company name, a charity name, government name, a school name, etc.; a symbol, a username; a software application name, and/or any other type of data that identifies an entity, e.g., a person, group of persons, a company, etc.

As shown in FIG. 3, the campaign message request 300 includes the request 310 and may include a telecommunications identifier 312 that represents a requested telecommunications identifier from which to send the campaign messages 200 (FIG. 2), and/or a telecommunications identifier which the entity 120 is approved to use. As such, upon approval of the campaign message request 300 by the approving authority, the telecommunications identifier 212 in the campaign messages 212 should be the same as and/or based in part on the telecommunications identifier 312. In embodiments, the campaign message request 300 may include a requesting entity identifier 314 (that identifies the requesting entity 120) and/or a corresponding encryption key 316 which can be used to authenticate the requesting entity 120.

As shown in FIG. 4, the approval message 400 may include an indication 410 of the approval or denial of the campaign message request 300 and/or a confirmation 412 of the campaign message request, e.g., a cryptographic hash of the campaign message request 300 (FIG. 3). The approval message 400 may include a telecommunications identifier 414 that is the same as and/or is based in part on the telecommunications identifier 312 in the campaign message request.

Referring to FIG. 5, the registrar 110 (also shown in FIG. 1) may include one or more servers 510 and one or more databases 512, 514, 516. While FIG. 5 depicts the server(s) 510 and database(s) 512, 514, 516 as forming part of the registrar 110, it is to be understood that one or more of these elements may reside external to the registrar 110, e.g., the server(s) 510 may be a part of the registrar 110 and the database(s) 512, 514, 516 may be external to the registrar 110 where the server(s) 510 communicate with the database(s) 512, 514, 516 via a network, e.g., network 132 (FIG. 1). In embodiments, a first database 512 may be a Toll-Free Number (TFN) Registry, and/or a second database 514 may be a Toll-Free Texting and Smart Services (TSS) Registry. In embodiments, the one or more databases 512, 514, 516 may include an IoT Device Registry that stores information identifying one or more IoT devices such an IoT device identifier, an IP address, a MAC address, etc., with corresponding attributes, e.g., a manufacturer of an IoT device, an owner and/or operator of an IoT device, location of an IoT device, known instances of malicious and/or suspicious behavior associated with an IoT device, a year of manufacturer of an IoT device, a hardware version number of the IoT device, a software version number of the IoT device, a firmware version number of the IoT device, and/or any other type of data/attribute appropriate for determining a reputation and/or trust score for an IoT device, as disclosed herein.

In embodiments, the one or more databases 512, 514, 516 may include a Network Device Registry that pairs IP addresses to corresponding attributes, e.g., an owner (and/or purported owner) of an IP address, a licensee (and/or purported licensee) of an IP address, an Internet Service Provider (ISP) associated with the IP address, a location (e.g., street address, mailing address, city, state, country, etc.) associated with the IP address, an entity (e.g., an individual, corporation, non-profit, government, etc.) associated with the IP address, and/or any other type of data/attribute appropriate for determining a reputation and/or a trust score for an IP address, as disclosed herein.

In embodiments, the one or more databases 512, 514, 516 may include a Fraud Registry that stores data associating a telecommunications identifier and/or an entity (an individual, corporation, non-profit, government, etc.) with instances of known and/or suspected fraudulent and/or criminal activities, e.g., wire fraud, identify theft, monetary theft, human trafficking, illegal drug manufacturing, illegal drug transportation/distribution, vehicle theft, and/or any other type of illegal, fraudulent, and/or otherwise malicious activities. In embodiments, the Fraud Registry may be included in and/or combined with a fraud network, as disclosed herein.

In embodiments, the one or more databases 512, 514, 516 may include a Business Registry, e.g., a state government business registry.

As will be understood, in embodiments, one or more aspects of the IoT Device Registry, the Network Device Registry, the Fraud Registry, the Business Registry, and/or any other type of registry described herein, may be incorporated into and/or otherwise combined with any of the databases and/or registries disclosed herein.

In embodiments, the registrar 110, when acting as the approval authority, may interpret the campaign message request 300 (FIG. 3) via the server(s) 510 and use the entity ID 314 to retrieve one or more records 518, 520, 522 from which the server(s) 510 may determine whether the entity 120 is authorized to use the requested telecommunications identifier 312 for a messaging campaign. In embodiments, the one or more records 518, 520, 522 may each include and/or be associated with a telecommunications identifier 524, which may be the same as and/or based on the requested telecommunications identifier 312.

In embodiments, a first record 518 from the TFN Registry 512 may include information related to which RespOrg owns which telecommunications identifiers and/or which entities are leasing and/or using the telecommunications identifiers. In embodiments, a second record 520 from the TSS Registry 514 may include information which telecommunications identifiers are authorized to transmit text messages, e.g., SMS, e-mails, and/or other types of text-based telecommunications.

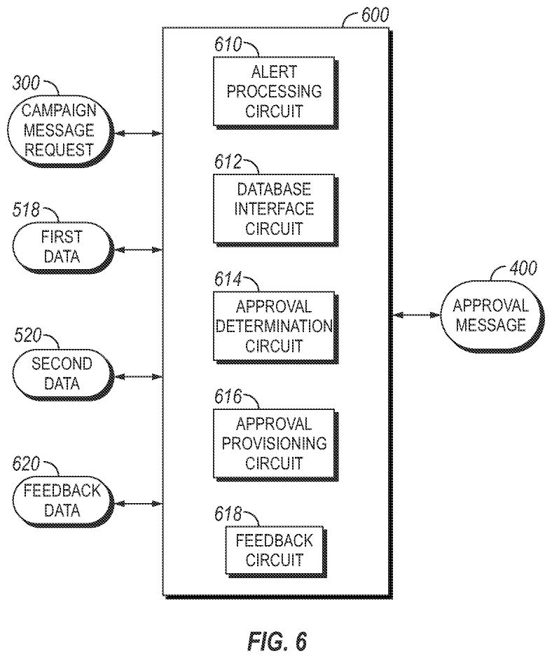

Accordingly, shown in FIG. 6 is an apparatus 600 for approving a campaign message request. The apparatus 600 may form part of the server(s) 510 and/or any other computing device disclosed herein, e.g., the campaign platform 116, the RespOrg 118, the MNOs 112, 114, etc. The apparatus 600 includes an approval processing circuit 610, a database interface circuit 612, an approval determination circuit 614, and an approval provisioning circuit 616. The approval processing circuit 610 is structured to interpret a campaign message request 300. The database interface circuit 612 is structured to retrieve one or more data sets, e.g., first data 518, second data 520, and/or third data 522, from one or more databases, e.g., 512, 514, and/or 516 (FIG. 5) based at least in part on the interpreted campaign message request 300. The approval determination circuit 614 is structured to determine, based at least in part on the first data 518, the second data 520, and/or the third data 522, whether an entity 120 identified 314 in the interpreted campaign message request 300 is authorized to use an identified telecommunications identifier, e.g., 312 (FIG. 3) for a messaging campaign. The approval determination circuit 614 is further structured to generate, based at least in part on the determination, an approval message 400. The approval provisioning circuit 616 is structured to transmit the approval message 400. In embodiments, the apparatus 600 may include a feedback circuit 618 structured to interpret feedback data 620, wherein the approval determination circuit 614 may be further structured to generate the approval message 400 based at least in part on the feedback data 620. The feedback data may be from a RespOrg 118 (FIG. 1), a campaign platform 116 (FIG. 1), an MNO 112, 114 (FIG. 1) and/or an entity 120 sponsoring a messaging campaign, targeted users 122, 124, 126, 128, 130 (FIG. 1) and/or any other entity associated therewith. For example, in embodiments, the feedback data 620 may be provided by an A2P provider which, in embodiments, may be in real-time or near real-time. In embodiments, the feedback data 620 may be used to adjust a reputation score, as disclosed herein. The feedback data 620 may indicate that the approval determination circuit 614 may be too restrictive or too liberal in approving messaging campaigns, as disclosed herein. For example, in a non-limiting example, the feedback data 620 may be from an MNO 112, 114 and/or the targeted users 122, 124, 126, 128, 130 and indicate the approval determination circuit 614 is too liberal in approving messaging campaigns, as disclosed herein, e.g., the feedback data 620 may be from an MNO 112, 114 and/or the targeted users 122, 124, 126, 128, 130 and indicate that the users 122, 124, 126, 128, and 130 are receiving a non-ideal and/or unacceptable level of SPAM purported to be from an approved telecommunications identifier and/or entity, as disclosed herein. In such a scenario, a reputation score associated with the entity and/or the telecommunications identifier may be decreased to decrease the likelihood of fraudulent messaging campaigns being approved which, in turn, may reduce the amount of SPAM reaching an MNO 112, 114 and/or targeted users 112, 124, 126, 128, 130. In embodiments, the feedback data 620 may be from an entity 120 sponsoring a messaging campaign and/or a campaign platform 116 and indicate that too many legitimate campaign message requests 300 are being denied by the approval determination circuit 614. In such a scenario, a reputation score associated with the entity and/or a telecommunications identifier associated with the denied requests may be increased to mitigate the likelihood of future legitimate campaign message requests associated with the entity and/or the telecommunications identifier from being denied by the approval determination circuit 614.

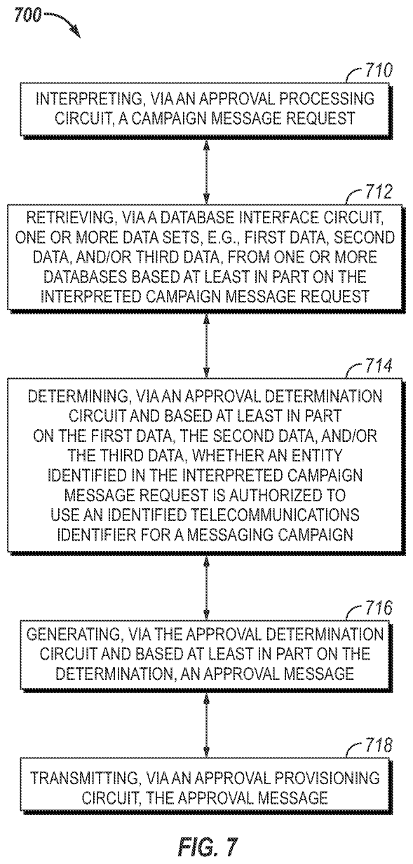

FIG. 7 depicts a method 700 for approving a campaign message request. The method 700 may be performed via the apparatus 600 (FIG. 6) and/or any other computing device disclosed herein. The method 700 includes interpreting, via an approval processing circuit, a campaign message request 710. The method 700 further includes retrieving, via a database interface circuit, one or more data sets, e.g., first data, second data, and/or third data, from one or more databases based at least in part on the interpreted campaign message request 712. The method 700 includes determining, via an approval determination circuit and based at least in part on the first data, the second data, and/or the third data, whether an entity identified in the interpreted campaign message request is authorized to use an identified telecommunications identifier for a messaging campaign 714. The method 700 further includes generating, via the approval determination circuit and based at least in part on the determination, an approval message 716. The method 700 further includes transmitting, via an approval provisioning circuit, the approval message 718.

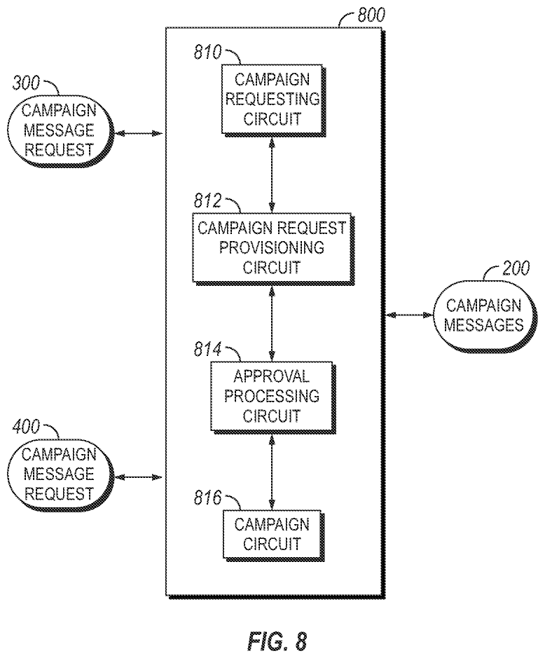

FIG. 8 shows an apparatus 800 for conducting a trusted messaging campaign. The apparatus 800 may form part of the entity 120 (FIG. 1) and/or the campaign platform 116 (FIG. 1) and/or any computing device disclosed herein. The apparatus 800 includes a campaign requesting circuit 810, a campaign request provisioning circuit 812, an approval processing circuit 814, and/or a campaign circuit 816. The campaign requesting circuit 810 is structured to generate a message campaign request 300 that includes a request 310 to execute a messaging campaign. The campaign request provisioning circuit 312 is structured to transmit the messaging campaign request 300 to an approving authority, e.g., the registrar 110 (FIG. 1). The approval processing circuit 814 is structured to interpret a campaign approval message 400 from the approving authority. The campaign circuit 816 is structured to transmit a plurality of electronic communications, e.g., campaign messages 200, in accordance with the messaging campaign.

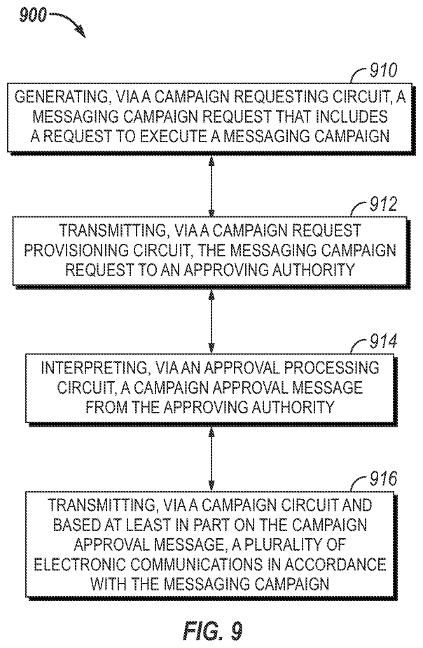

FIG. 9 depicts a method 900 for conducting a trusted messaging campaign. The method 900 may be performed via the apparatus 800 (FIG. 8) and/or any other computing device disclosed herein. The method 900 includes generating, via a campaign requesting circuit, a messaging campaign request that includes a request to execute a messaging campaign 910. The method 900 further includes transmitting, via a campaign request provisioning circuit, the messaging campaign request to an approving authority 912. The method 900 further includes interpreting, via an approval processing circuit, a campaign approval message from the approving authority 914. The method 900 further includes transmitting, via a campaign circuit and based at least in part on the campaign approval message, a plurality of electronic communications in accordance with the messaging campaign 916.

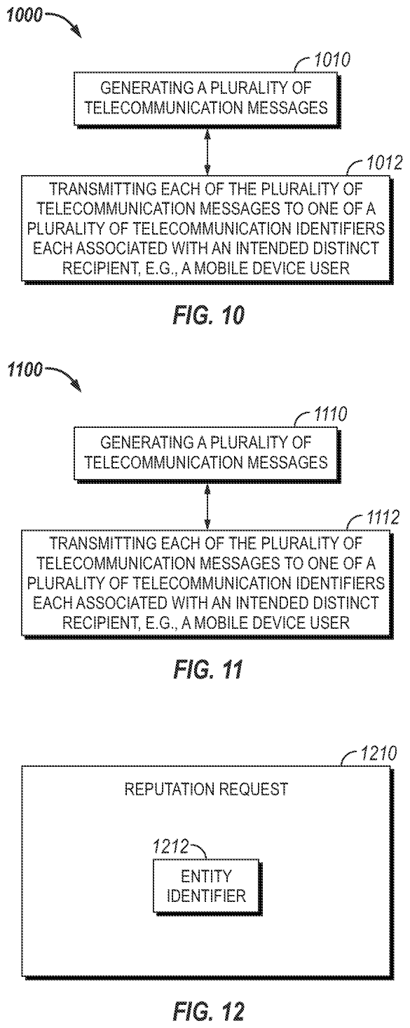

FIG. 10 depicts a method 1000 for executing a messaging campaign. The method 1000 may be performed via one or more processors of the entity 120 (FIG. 1) and/or the campaign platform 116 (FIG. 1) and/or any computing device disclosed herein. The method 1000 includes generating a plurality of telecommunication messages 1010; and transmitting each of the plurality of telecommunication messages to one of a plurality of telecommunications identifiers each associated with an intended distinct recipient, e.g., a mobile device user, 1012. In embodiments, each of the plurality of telecommunication messages is associated with a short code.

FIG. 11 depicts a method 1100 for executing a messaging campaign. The method 1100 may be performed via one or more processors of the entity 120 (FIG. 1) and/or the campaign platform 116 and/or any computing device disclosed herein. The method 1100 includes generating a plurality of telecommunication messages 1110; and transmitting each of the plurality of telecommunication messages to one of a plurality of telecommunications identifiers each associated with an intended distinct recipient, e.g., a mobile device user, 1112. In embodiments, each of the plurality of telecommunication messages is associated with a same ten-digit code.

Referring now to FIGS. 1 and 5, as disclosed herein, in embodiments, the registrar 110 may provide for reputation scoring of entities 120 (FIG. 1) where the reputation score may be used to regulate the entities' access to telecommunication resources, e.g., originating telecommunication messages, such as making calls, sending text messages, executing messaging campaigns, etc. In embodiments, the reputation scoring may be based on data contained within one or more of the databases 512, 514, 516 (FIG. 5). For example, in embodiments, the one or more servers 510 of the registrar 110 may interpret a reputation request 1210 (FIG. 12) that includes an identifier 1212 for an entity, e.g., entity 120 (FIG. 1), and retrieve data 518, 520, 522 from the databases 512, 514, 516 which may then be processed/analyzed to generate a reputation score for the entity. In embodiments, the server(s) 510 may generate a score for an entity on demand, e.g., in response to a reputation request 1210. In embodiments, the server(s) 510 may continuously and/or periodically generate a reputation score for an entity, e.g., 120 (FIG. 1) and store the score in a field of a record 518, 520, and/or 522 in one or more of the databases 512, 514, and/or 516 for retrieval at a later date. In embodiments, the server(s) 510 may calculate the reputation score of an entity on an hourly, daily, weekly, monthly, annual, and/or a decade basis, and/or on any subdivision thereof.

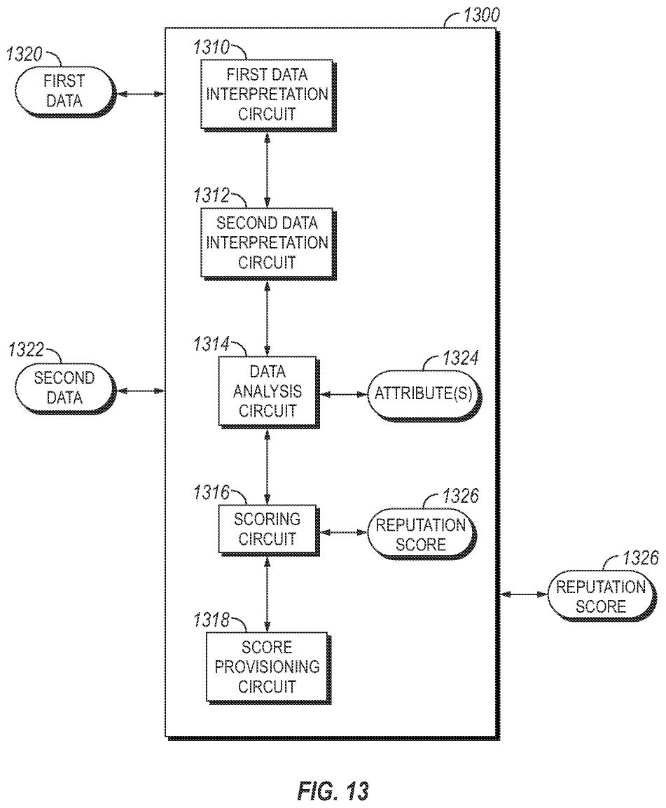

Accordingly, illustrated in FIG. 13 is an apparatus 1300 for assigning reputation scores to telecommunications identifiers. The apparatus 1300 may form part of the one or more servers 510 (FIG. 5) and/or any other computing device disclosed herein. In embodiments, the apparatus 1300 includes a first data interpretation circuit 1310, a second data interpretation circuit 1312, a data analysis circuit 1314, a scoring circuit 1316, and/or a score provisioning circuit 1318. The first data interpretation circuit 1310 is structured to interpret first data 1320 (corresponding to one of 518, 520, or 522 in FIG. 5) from a first database, e.g., one of 512, 514, or 516, where the first data 1320 corresponds to a telecommunications identifier, e.g., 524 (FIG. 5). The second data interpretation circuit 1312 is structured to interpret second data 1322 (corresponding to one of 518, 520, or 522 in FIG. 5 distinct from the first data 1320) from a second database, e.g., one of 512, 514, or 516 distinct from the first database. For example, in embodiments, the first data 1320 may be a record 518 (or data based in part on the record) from a TFN registry 512 and the second data 1322 may be a record 520 (or data based in part on the record) from a TSS registry 514, where both the first data 1320 and the second data 1322 correspond to a same at least one telecommunications identifier, e.g., 524 (FIG. 5). The data analysis circuit 1314 is structured to determine, based at least in part on the first data 1320 and the second data 1322, one or more attributes 1324 for the at least one telecommunications identifier, e.g., 524 (FIG. 5). The scoring circuit 1316 is structured to generate, based at least in part on the one or more attributes 1324, a reputation score 1326 for the at least one telecommunications identifier, e.g., 524 (FIG. 5). The score provisioning circuit 1318 is structured to transmit the reputation score 1326.

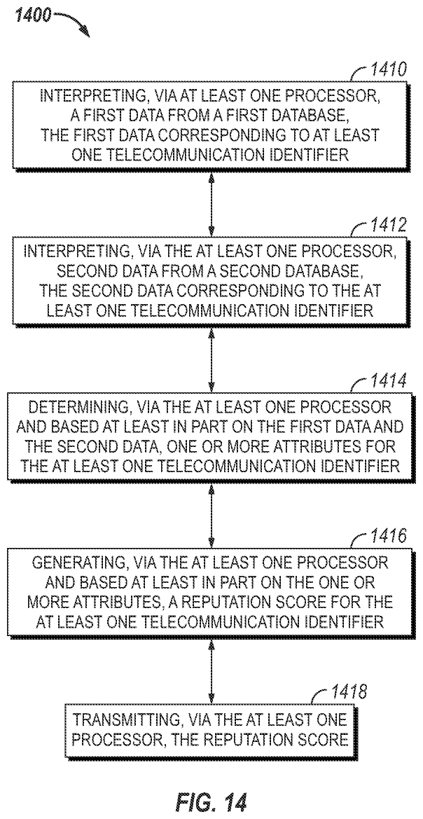

FIG. 14 depicts a method 1400 for assigning reputation scores to telecommunications identifiers. The method 1400 may be performed via apparatus 1300 (FIG. 13) and/or any computing device disclosed herein. The method 1400 includes interpreting, via at least one processor, a first data from a first database, the first data corresponding to at least one telecommunications identifier 1410. The method 1400 further includes interpreting, via the at least one processor, second data from a second database, the second data corresponding to the at least one telecommunications identifier 1412. For example, as with the apparatus 1300, in embodiments, the first data may be a record 518 (or data based in part on the record) from a TFN registry 512 and the second data may be a record 520 (or data based in part on the record) from a TSS registry, where both the first data and the second data correspond to a same at least one telecommunications identifier, e.g., 524 (FIG. 5). The method 1400 further includes determining, via the at least one processor and based at least in part on the first data and the second data, one or more attributes for the at least one telecommunications identifier 1414. The method 1400 further includes generating, via the at least one processor and based at least in part on the one or more attributes, a reputation score for the at least one telecommunications identifier 1416. The method 1400 further includes transmitting, via the at least one processor, the reputation score 1418.

While the apparatus 1300 and method 1400 are described herein with respect to determining a reputation score for telecommunications identifiers, it is to be understood that embodiments of the apparatus 1300 and/or method 1400 may determine a reputation score for an entity, e.g., 120 (FIG. 1), wherein the first data 1320 and the second data 1322 correspond to the entity 120, as well as the attributes 1324. As such, in embodiments, the reputation score 1326 may be for an entity 120.

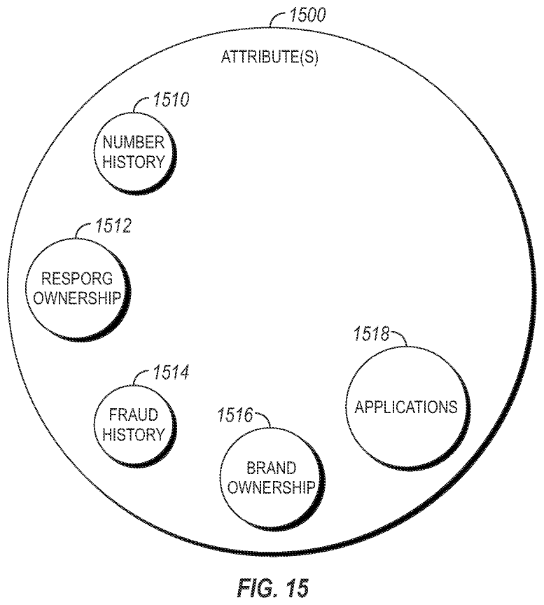

FIG. 15 depicts various types of attributes 1500 (corresponding to 1324 in FIG. 13), and/or attribute groups, which may be determined by analyzing the data 518, 520, and/or 522 (FIG. 5) retrieved from the one or more databases 512, 514, and/or 516 (FIG. 5). As will be appreciated, an attribute may represent one measure of a telecommunications identifier's reputation, e.g., reliability, stability, longevity demand, brand value, and/or fraud profile. As disclosed in greater detail herein, certain embodiments of the current disclosure may generate individual attributes using one or more of the following three methods: simple formulae, proprietary algorithms, or artificial intelligence (AI) including micro-AI, e.g., for word and/or number pattern detection.

Some attributes, e.g., churn, growth rates, etc., may be calculated using formulae and/or further adapted to one or more: underlying data sources, length of available data, analyses of validity of and contribution to the final score of a TFN, or the like. In other words, certain embodiments of the current disclosure may tailor one or more attributes based on the type and/or amount of data available. Such adjusting and/or tailoring may be in real-time (or near-real time), and may be performed on a periodic basis, e.g., annually, monthly, weekly, daily, etc. Thus, some embodiments provide for attributes that improve in accuracy over time as more data becomes available, and/or reduce in accuracy in the event data becomes unavailable. Embodiments of the current disclosure may provide an accuracy indicator that accompanies an attribute, where the accuracy indicator may be based at least in part on the amount, length, and/or type of data available to generate a particular attribute.

Some embodiments may include algorithms to summarize certain attributes that may be a product of multiple datapoints, e.g., derived, and/or otherwise based at least in part, from different/distinct products and/or APIs or data streams. As a non-limiting example, such a (sometimes) complex attribute includes assessed demand (e.g., value) of a telecommunications identifier, e.g., a TFN. In such embodiments, the registrar may aggregate demand for the telecommunications identifier from multiple APIs and/or interfaces, and then identify rogue and/or patterned interactions with the databases 514, 512, and/or 516 from machines and/or robots. The registrar may then scale any identified interactions and/or filter them (which may be a complete filtering) to generate a holistic demand attribute for that telecommunications identifier.

In some embodiments, select attributes may be generated using micro-level AI that may perform look-alike, number, and/or word pattern analyses of a telecommunications identifier, itself. As a non-limiting example, to assess value of a telecommunications identifier, one or more of the apparatuses disclosed herein may train algorithms and/or models, e.g., micro-level AIs, to identify high value telecommunications identifiers suitable for brand recall, and/or those with specific patterns of digits and/or words that are compliant with any controlling guidelines, e.g., numbering guidelines.

While the below attributes are described with respect to TFNs, it is to be understood that the disclosed concepts may also apply to telecommunications identifiers, generally, e.g., local numbers, email addresses, short codes, 10-digit codes, social media usernames/accounts, etc. Non-limiting examples of attribute groups include: number history 1510; RespOrg ownership/profile 1512; fraud history 1514; brand ownership 1516, and/or applications 1518. The number history 1510 grouping may include attributes corresponding to a TFN's characteristics in a TFN registry, e.g., 512 (FIG. 5) that capture a TFN's value, stability, cleanliness (e.g., the level of any suspicious activity associated with the telecommunications identifier), longevity, and/or reliability. In embodiments, the number history 1510 grouping may include usability, NPA, service age, current age in service, number of times spared, number of times reserved, number of days in and out of service, current length of time currently in service, etc. As will be understood, in embodiments, the number history attributes used or TFN reputation scoring, as disclosed herein, may be calculated by the registrar 110 using formulae/algorithms on number history datasets generated via TFNR operations. As will be understood, such number history datasets may not be natively available to toll-free number administration (TFNA) operations, and hence, not available to all RespOrgs. In embodiments, individual number history attributes may be contained within a registrar 110 so that access and/or exposure to entities outside of the registrar 110 is restricted and/or prevented. In embodiments, a TFN's history may be limited to its current ownership. In embodiments, a TFN's history may span its entire lifetime irrespective of ownership. In other words, in embodiments, number histories may only be packaged and released outside the registrar in the form of a reputation score. The RespOrg ownership grouping 1512 may include attributes corresponding to component(s) of a TFN's reputation derived from and/or otherwise based on its ownership by one or more RespOrgs. In embodiments, RespOrgs may be scored based on number management behaviors, e.g., porting and/or churn activity in a TFN 512 and/or TSS 514 registry, growth rates, and/or a segmentation based on a RespOrg's focus in the TFN marketplace. In embodiments, the RespOrg ownership grouping 1512 may include attributes that capture a RespOrgs transactional behavior, including porting, churn activities, and/or products/services offered to end customers. Attributes in the RespOrg ownership grouping 1512 may have a directional impact on TFNs owned by the corresponding RespOrg. Further non-limiting examples of RespOrg ownership grouping 1512 attributes include TFN portability, service registrar portability, transaction activity, etc. Further non-limiting examples of the RespOrg ownership grouping 1512 include: churn rate for TFN and TSS, a text enabled ratio, a size of the entity, what is the entity's growth profile, transaction violations, payment violations, etc. The fraud history grouping 1514 may include attributes corresponding to knowledges regarding fraudulent activities related to a TFN, e.g., knowledge of any billing or transactional frauds committed on and/or otherwise affiliated with a TFN, whether the entity or telecommunications identifier has ever been identified as committing fraud and/or the length of time the entity and/or telecommunications identifier was listed as being fraudulent. In embodiments, knowledge regarding fraudulent activities related to a TFN may be stored in a fraud network operated by a registrar, e.g., 110 (FIG. 10), e.g., database 516 (FIG. 5). The fraud network may include historical fraud data for TFNs, entities, and/or related transactions associated therewith. In embodiments, the fraud network may collect data from different entities operating in the telecommunications ecosystem, e.g., 100 (FIG. 1), such as RespOrgs 118, MNOs (112, 114), campaign platforms 116, entities 120 that use the campaign platform 116, and the like. In embodiments, the fraud history grouping 1514 may include age since last fraud report, company class reporting fraud, etc. The brand ownership grouping 1516 may include attributes corresponding to knowledge and/or depth of interest of a brand owning a particular TFN. In embodiments, the brand ownership grouping 1516 may include attributes related to the depth of a brand ownership of a TFN as identified/known to a TFN registry database. As will be understood, in embodiments, a confirmation (and/or verification) of brand's/entity's ownership of a TFN has a positive impact on the TFN's and/or brand's/entity's reputation. In embodiments, the brand ownership grouping 1516 may include attributes derived and/or otherwise based on all of a brand's touchpoints with a registrar, e.g., 110, outside of a TFN 512 and/or a TSS 514 registries. Embodiments of the current disclosure may also use data masking techniques to anonymize the underlying data used to generate a reputation score, e.g., all ratios used within a reputation scoring may be generated via anonymized and/or aggregated data across RespOrgs and/or time periods. Non-limiting examples of brand ownership grouping 1516 attributes include: vanity or special sequence TFNs, brand verification, brand interest, etc. Further non-limiting examples of the brand ownership grouping include: repeat uses, sequence TFNs, Vanity TFNs, TFNs in active number management, e.g., CNAM reports, DNO flags, etc. The applications grouping 1518 may include attributes corresponding to depth of use of a TFN across multiple applications, e.g., do not originate (DNO), CNAM, and/or longevity of their use within such applications, e.g., embedding of a TFN in an application. In embodiments, a TFN and/or entity reputation score, as disclosed herein, may be based on a weighted ordering of attributes 1500. In embodiments, the weighting of the attributes may be based in part on their order within a listing. In embodiments, the listing may include twenty or more attributes, which may be maintained by the registrar 110. In embodiments, the attributes 1500 may be deterministic and/or be (or are derived from) first-party data. In embodiments, status as a vanity and/or special telecommunications identifiers may be an attribute and/or otherwise factored into a reputation score. In embodiments, application adoption, e.g., an amount and/or number of times a telecommunications identifier is used for an application (such as TFN like messaging, voice calls, CNAM display, do not originate (DNO) listings, Internet of Things, etc.), may be an attribute. As will be understood, the more a telecommunications identifier is used for an application (or across applications) the higher its importance may be. Non-limiting examples of the applications grouping 1518 attributes include applications enabled on the TFN, TFN application age index, etc. Further non-limiting examples of the applications grouping 1518 attributes include: a RespOrg business model, segment growth (which may be weighted by an amount of time the TFN is with the RespOrg), etc. In embodiments, the attributes 1500 may include a telecommunications identifier's reliability, value (economic), cleanliness, stability, longevity, fraud risk, etc. In embodiments, the attributes 1500 may include a length of time that the telecommunications identifier and/or an entity, e.g., 120 (FIG. 1) has been in existence. For example, the longer an entity has been around, the lower the likelihood the company was formed for fraudulent purposes and the more trustworthy the entity (and/or its associated telecommunications identifiers) likely is. As another example, “1-800” numbers, on average, may be more trustworthy than “1-811” numbers as the “1-800” prefix has been in existence longer. Additionally, telecommunications numbers with high churn rates may be less trustworthy than telecommunications identifiers with lower churn rates.

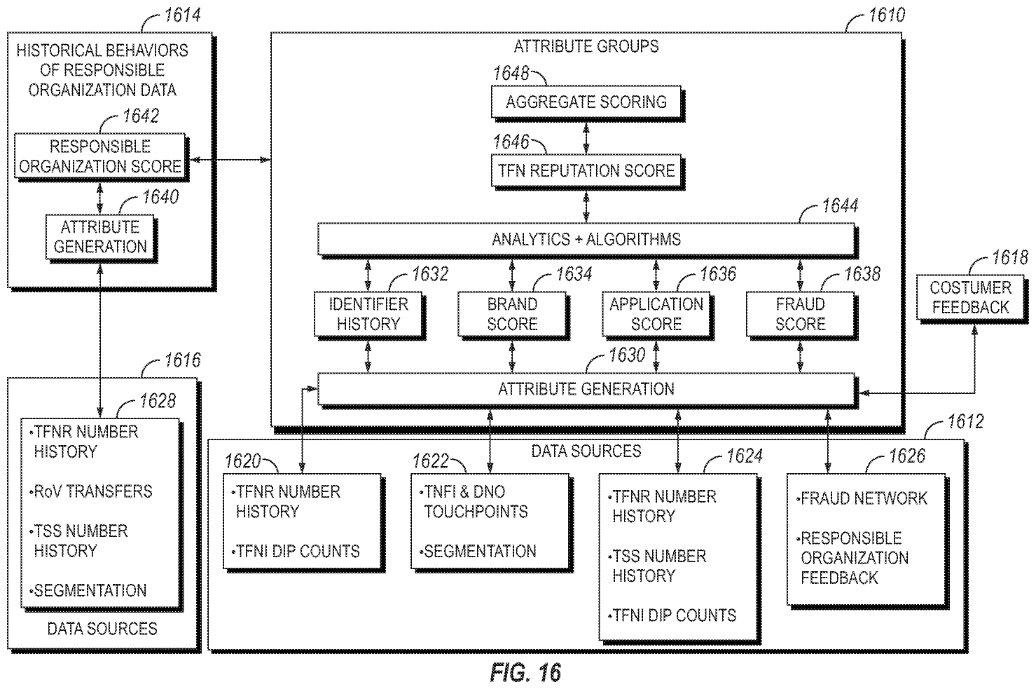

FIG. 16 depicts a block diagram of further various components and/or procedures which may be incorporated into embodiments of the apparatus 1300 (FIG. 13) and/or method 1400 (FIG. 14) for determining the one or more attributes 1500 (FIG. 15), which may be implemented by data analysis circuit 1314 (FIG. 13). For example, in embodiments, generation of a reputation score 1326 (FIG. 13) may be based on determining one or more attribute groups 1610, e.g., groups of the attributes 1500 (FIG. 15) based on current data from data sources 1612, historical behavior data of RespOrgs 1614 from data sources 1616, and/or customer feedback 1618. The historical behavior data may be sampled and/or otherwise include historical data within a specified time period defined, in part, by a first timestamp and a second timestamp. The first timestamp may be: the earliest available date historical behavior was collected regarding a RespOrg; ten (years) in the past; five (5) years in the past; one (1) year in the past; six (6) months in the past, etc. The second timestamp may be: the most recent date the reputation score was calculated, e.g., the day of calculation/generation of the reputational score; one (1) day prior to the day of calculation/generation of the reputation score; one (1) week prior to the day of calculation/generation of the reputation score; one (1) month prior to the day of calculation/generation of the reputation score, etc.

In embodiments, data sources 1612 may include: TFNR number history, and/or TFNI Dip counts 1620; TFNI and DNO touchpoints (e.g., whether a RespOrg or Brand/Enterprise provided additional information regarding their TFN), and/or segmentation 1622; TFNR number history, TSS number history, and/or TFNI & DNO touchpoint 1624; data from a fraud network, and/or RespOrg feedback 1626; and/or other data sources related to telecommunications. As will be understood, segmentation 1622 may include different classifications for an entity type associated with a telecommunications identifier, e.g., different RespOrgs may be separated into different categories based on one or more properties, e.g., area of focus, products and services offered, etc. In embodiments, data sources 1616 may include: TFNR number history, Responsible Organization Change (RoC) Transfers, TSS number History, and/or segmentation data 1628. A RoC may include transfers of a TFN from one RespOrg to another RespOrg. Such transfers are generally approved by the enterprise owning and/or leasing the TFN being transferred. In embodiments, the TFNR number history may include a log of TFNR actions performed by RespOrgs for their TFNs, e.g., reserve, spare, etc. In embodiments, RespOrgs may be able to view each other's number histories. In embodiments, the registrar 110 (FIG. 1) may restrict the ability of RespOrgs to view each other's number histories, where such restrictions may be for a pre-determined amount of time. For example, the registrar 110 may limit a RespOrg to view the number history of a TFN only during the period the RespOrg owns and/or is leasing the TFN from the TFNR.

In embodiments, data from data sources 1612 and/or customer feedback 1618 may flow to an attribute generation process 1630 which, in turn, may generate one or more of the following sub-component scores: an identifier history 1632, a brand score 1634, an application score 1636, and/or a fraud score 1638. The customer feedback 1618 may be from users in one or more portions of the telecommunications ecosystem, e.g., the system 100 (FIG. 1). The feedback 1618 may include notices of good and/or bad behavior by a telecommunications identifier. Non-limiting examples of good behavior include not being associated with fraudulent activity, being associated with known approved messaging campaigns, being associated with positive experiences by mobile device users 122, 124, 126, 128, 130 (FIG. 1), etc. Non-limiting examples of bad behavior include being associated with fraudulent activity such as number masking, spoofing, SPAM, negative experiences by mobile device users 122, 124, 126, 128, 130 (FIG. 1), etc. As further shown in FIG. 16, data from data source 1616 may be processed by the historical behavior data of RespOrgs 1614 component/procedure to determine historical behaviors of a RespOrg. For example, data from the data sources 1616 may be processed by an attribute generation component/procedure 1640 to generate a RespOrg sub-component score 1642. In embodiments, historical behaviors may include activities within three (3) years from the date the reputation score was determined. Non-limiting examples of historical behavior include RespOrg actions, e.g., active/inactive status changes, transfers to/from other RespOrgs, and/or payment/TX violations across all TFNs that the RespOrg has owned over the behavior period. The sub-component scores, 1632, 1634, 1636, 1638, and/or 1642 may then be fed to an analytics and algorithms component/procedure 1644 which generates a TFN reputation score, e.g., 1646 (corresponding to 1326 shown in FIG. 13). In embodiments, multiple TFN reputation scores 1646 may be generated for a same telecommunications identifier and sent to an aggregate scoring component/procedure 1648 to generate an aggregate reputation score. In embodiments, aggregate reputation scores may be generated by aggregating reputation scores for a group of numbers where the aggregate reputation score represents a group score. In embodiments, a group score may represent the risk associated with a group of telecommunications identifiers.

As will be appreciated, in embodiments, once attributes are calculated, validity and eligibility of each attribute for inclusion (in a reputation score) may be tested using statistical analyses, e.g., 1644 (FIG. 16). Attributes and their contributions may also be tested for variance from their own historical contributions for continued consistency of scoring.

In some embodiments, the generated attributes are grouped and/or combined using weighting methods, as disclosed herein, which may be educated/trained/tuned/adjusted by statistical analyses of individual attributes, e.g., the registrar's knowledge of the industry, knowledge from and/or stored (as data) in one or more of the databases 512, 514, 516 (FIG. 5) and/or the source or quality of data sources used in the calculation, e.g., data sources 1612, 1616, and/or user feedback 1618.

In embodiments, additional feedback loops may be formed between the registrar and one or more external ecosystem participants and/or sources. As will be appreciated, additional techniques, as disclosed herein, and/or advanced AI algorithms, e.g., certain AI algorithms more comprehensive in size, accuracy, and/or requiring more computing resources than the micro-level AI algorithms disclosed herein, may be used to convert feedback signals into existing and/or new attributes that may educate and/or aligning reputation scoring of telecommunications identifiers, as disclosed herein, with real-world performance of the telecommunications identifiers.

In embodiments, the algorithms component/procedure 1644 may be implemented by the scoring circuit 1316 (FIG. 13). Embodiments of the scoring circuit 1316, and/or any other computing device disclosed herein, may calculate/generate reputation scores of telecommunications identifiers via one of more of: statistical analyses; weighting algorithms (that may be based at least in part on a registrar's knowledge and insights regarding various entities within an industry, e.g., RespOrgs in the TFN Industry, as a whole); and/or a machine learning techniques wrapped with additional algorithms that may be based at least in part on the registrar's knowledge of numbering plans and/or the industry.

In embodiments, the weighting algorithms may assign weights to both attributes and their groups and use various weighting techniques, as disclosed herein, to calculate/generate a telecommunications identifier's reputation score. Weighting of an individual attribute within its corresponding group may be based at least in part on, e.g., educated via, an origin and/or a source of underlying data, a measure of quality the attribute represents, etc. These weights may be adjusted from time-to-time to account for and/or incorporate data corresponding to developments in industry. As will be appreciated, such adjusting of weights may serve to keep (or assist in keeping) the reputation scores generated, in accordance with this disclosure, by the scoring circuit 1316 in sync with market conditions. As a non-limiting example, if new application uses of reputation scores are introduced in the market, the registrar would be able to introduce a new RespOrg segment focused on facilitating use of telecommunications identifiers in such applications, re-weight an application group and/or the attributes within, and/or other similar processes.

One or more machine learning techniques, as disclosed herein, may also be used (which may be in parallel to a weighting approach, as also disclosed herein) to identify telecommunications identifiers that have similar characteristics in terms of quality metrics as represented by their attributes. Such learning outputs may be further tested for biases and outliers, subject to statistical analyses to verify their validity and applicability to scoring before being used to calculate a telecommunications identifier's reputation score. In embodiment, pre-final reputation scores (reputation scores that may be combined and/or certified before becoming a finalized reputation score) generated from both weighting and machine learning methods may be compared and, when found different, subjected to further automated analyses to determine which of the pre-final reputation scores is the most accurate (or believed/determined by the automated process to be the most accurate) score and, in some cases, identify/determine that the telecommunications identifier cannot be assigned a reputation score and/or a profile. In embodiments, the inconclusive telecommunications identifiers are analyzed manually to identify improvements to the methods discussed herein.

In some embodiments, once a plurality of telecommunications identifiers have been scored, they may be separated by their use in voice and/or text ecosystem applications. Statistical analyses may also be used to examine/identify distributions of reputation scores, compare the distributions with historical spreads, identify and/or eliminate biases and/or deviations within the distributions to maintain consistency and accuracy of the reputation scores.

Accordingly, in embodiments, the component/procedure 1644 may consider/receive as input twenty-two (22) or more attributes which may be spread over five (5) or more attribute groups. In embodiments, the record 518 (FIG. 5) in a database 512 for a particular telecommunications identifier 524 may include a score value 526 (FIG. 5) and/or a risk-delta value 528. The score value 526 may be a running score that is maintained and updated over the lifespan of the telecommunications identifier 524. The risk-delta value 528 may be an up/down rusk processing signal, e.g., the risk-delta value 528 may be a counter provided by an A2P provider via one or more API calls (FIG. 18) that is adjusted and/or is maintained for the lifespan of a campaign. In embodiments, the default value of the risk-delta value 528 may be zero (0) at the beginning of a campaign which is then incremented for each telecommunications identifier that is added to the campaign. In embodiments, the risk-delta value 528 may be reset back to the default value upon the detection of an end of a campaign. A campaign may be determined to have ended when a telecommunications identifier is regrouped and/or reassigned a different campaign ID and/or SGID. In embodiments, the ending of a campaign may mark a new feedback cycle of the TFN. In embodiments, an A2P provided risk indicator may be treated as a Level-1 positive number attribute within the reputation score generation process, as disclosed herein.

As shown in table 1, in embodiments, the aggregate scoring procedure/module, e.g., 1648 (FIG. 16) may provide reputation scores having discrete values, e.g., “Good”, “Bad”, etc.

TABLE 1

| Aggregator Reputation | Customer | Notes |
|---|---|---|
| Good | 1 | May have bad actors on |
| | | their platform, but by and |
| | | large, traffic is wanted and |
| | | low % spam and opt outs. |
| Good | 2 | May have bad actors but |
| | | they are dealt with quickly |
| | | and small % of spam and |
| | | opt outs. |
| Good | 3 | Almost no spam (1.4k |
| | | spam messages for entire |
| | | account, 57k opt out of |
| | | 21M messages). |
| Good | 4 | 1% opt out, no spam. |
| Good | 5 | No spam. |
| Bad | 6 | 67% delivered (21% spam, |
| | | 3.4% opt out). |
| Bad | 7 | 87% delivered (5.3% |
| | | carrier spam). |
| Bad | 8 | 84% delivered (4% carrier |
| | | spam). |
| Bad | 9 | 79% delivered (4.23% |
| | | spam, 3% carrier rejected). |
| Bad | 10 | 91% delivered (4.4% |
| | | spam). |
| Aggregator may | 11 | 73% delivered (3.4% opt |
| not be a RspOrg | | out, no spam) - 34 TFNs. |
| Aggregator may | 12 | 90% delivered, not a lot of |
| not be a RspOrg | | spam but 3.5% carrier |
| | | rejected - 3062 TFNs. |

In embodiments, an aggregate or group score generated by procedure/module 1648 may describe the reputation of telecommunications identifiers and/or, inversely, risk associated with a group of selected/identified telecommunications identifiers, as compared with that of all telecommunications identifiers scored as a group. In embodiments, an aggregate score for a specified/selected/identified group of telecommunications identifiers may be calculated and presented for application use in real-time, or near real-time, by leveraging pre-calculated reputation scores of individual telecommunications identifiers within the specified/selected/identified group.

As described herein, telecommunications reputation scores may be used to enable use cases in voice and/or text messaging systems and/or for display of a telecommunications identifier on variety of output consoles. As such, embodiments of the current disclosure may provide for the presentation of reputation scores with label(s) in a graphical user interface. In such embodiments, numerical telecommunications identifier reputation scores may be labeled for a particular use-case. The labelling may be numerical scaling. In such embodiments, the scaling may be based at least in part on a scale required by a particular application, e.g., binary based for a reputation/risk threshold pre-declared by an application, categorical labelling, color coding, binary as necessary for decision making, etc.

In embodiments, the aggregate scoring procedure 1648 may access shared scoring data for more than one TFN in the TFN 512 and/or TSS 514 registries, e.g., 60K TFNs. Embodiments of the current disclosure may provide for matching of fraudulent knowledge concerning a telecommunication identifier known by the one or more servers 510 (FIG. 5) to actual number reputation knowledge (qualitative or observed) known by an aggregator concerning the telecommunication identifier. Embodiments of the current disclosure may provide for matching of fraudulent knowledge concerning a telecommunication identifier known by the one or more servers 510 (FIG. 5) to a campaign platform's own knowledge (qualitative or observed) of fraudulent activity for the telecommunication identifier. In embodiments, matching of knowledge known by the one or more servers 510 to other knowledge known by other entities may be provided via one or more feedback loops, as disclosed herein. One non-limiting example of data collected via the one or more feedback loops is third-party data collected from: customers of the registrar 110 (FIG. 1), service providers, and/or independent (and/or commercial) fraud reporting platforms within an ecosystem, e.g., a telecommunications system 100 (FIG. 1). In embodiments, the dates of a messaging campaign may be used to adjust and/or refine the attributes 1500 (FIG. 15) used to generate a reputation score.

As will be appreciated, embodiments of the current disclosure provide for process/processing flows that transform first and/or third-party collected data into attribute values, e.g., raw attribute values, that may provide for the basis of a reputation score. For example, certain embodiments of the current disclosure may us a data process/processing flow that combines data from one or more data-streams, e.g., data sources 1612, customer feedback 1618, and/or data sources 1616 (FIG. 16), assign an industry segment to a corresponding telecommunications identifier, and organizes and/or optimizes the processed data for generation of attributes. In embodiments, individual attributes may then be calculated, grouped, and/or combined using purpose-driven analytics and/or algorithms, as disclosed herein, to calculate a score for the telecommunications identifier.

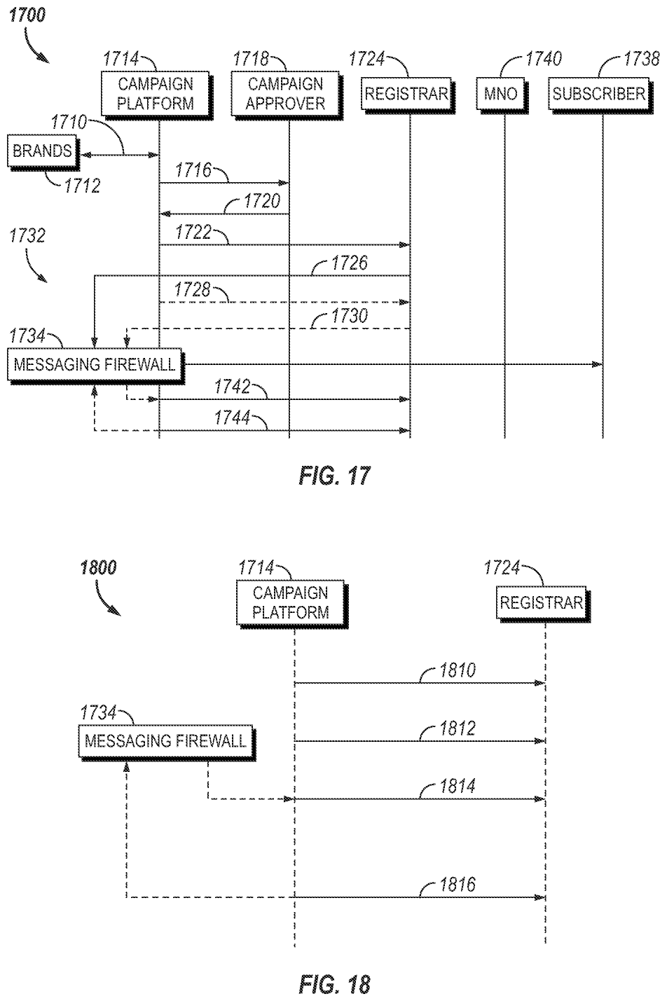

Illustrated in FIG. 17 is a process flow 1700 for executing a trusted messaging campaign, in accordance with embodiments of the current disclosure. At 1710, an entity/brand 1712 sends a campaign request to a campaign platform 1714. At 1716, the campaign platform 1714 registers the entity 1712 with a campaign approver 1718 who, in response, provides the campaign platform 1714 with a campaign ID at 1720. At 1722, the campaign platform 1714 sends the campaign ID with a list of telecommunications identifiers, e.g., TFNs, to a registrar 1724 who assigns a group ID (which may be the same as the campaign ID) and generates a risk index for the requested campaign. At 1726, the registrar 1724 returns/echoes the campaign ID with the risk index back to the campaign platform 1714. Optionally, at 1728, the campaign platform 1714 requests, from the registrar 1724, a watch list of high risk telecommunications identifiers associated with the campaign ID and the registrar 1724 returns the same back to the campaign platform 1714 at 1730. At 1732, the campaign platform 1714 may input all (or just the high risk) telecommunications identifiers into its firewall(s) via a messaging firewall 1734. In embodiments, the messaging firewall 1734 may be operated and/or owned by the campaign platform 1714. In embodiments, the messaging firewall 1734 may be operated and/or owned by entities other than the campaign platform 1714, e.g., a third party, the registrar 1724, the MNO 1740, etc. The messaging firewall 1734 may provide for various security features and/or regulate messaging traffic which may include a request 300 (FIG. 8) by a brand 1712 to launch a campaign and/or campaign messages 200 (FIG. 8) and/or other types of A2P traffic. Regulation of the messaging traffic by the firewall 1734 may include monitoring the messaging traffic for compliance against pre-defined standards to include discrimination of traffic types with respect to being allowed to pass through the firewall 1734. The messaging firewall 1734 may provide for traffic management and/or analytics of the messaging traffic. In embodiments, the functions of the registrar 1724 (as disclosed herein) may be agnostic to the particularities of the messaging firewall 1734, e.g., the functionality of the registrar 1724 may work with any particular type and/or brand of messaging firewall 1734. In embodiments, messaging traffic regulation and/or discrimination may be based on reputation scores, as disclosed herein. At 1736, the campaign platform initiates the messaging campaign by sending electronic communications, e.g., text messages, emails, etc., to mobile device operators 1738 via a mobile network operator 1740. At 1742, the campaign platform 1714 may send feedback to the registrar 1724. Such feedback may relate to the telecommunications identifiers, MNO error codes, spam message counts, and/or the like.

In embodiments, the feedback may be provided voluntarily by RespOrgs, MNOs, campaign providers, mobile device users and the like. At 1744, the campaign platform 1714 dips into the registrar 1724 to get updated telecommunications identifier risks, which the messaging firewall 1734 may use to adjust its watchlist.

As will be understood, as shown below in Table 2, A2P messaging platforms, e.g., campaign platforms 116, can complement the brand score 1634 from TCR with the TFN registry 512 (FIG. 5) to identify high risk text-campaigns before they are launched and/or monitor/manage these campaigns throughout their lifecycles.

TABLE 2
Combining Customer Scoring with TFN-level scoring

| | | High Risk Customers | |
|---|---|---|---|
| | All | *170k-Individual TFNs and | |
| | Customer | their Groups (Customers) | |
| | TFNs | identified by an A2P platform | |
| Treatment Plan | Treating | | Treating |
| based on Somos | High Risk | Treating | High Risk |
| Scores | TFNs | All TFNs | TFNs |
| Size of Watchlist | 31,283 (18.4%) | 70,771 (41.6%) | 21,306 (12.5%) |
| (% of Mo. TFNs) | | | |
| Spam Reduction | 16.33% | 36.59% | 10.65% |
| Rate | | | |
| Messages | 107.43% | 251.61 | 76.23% |
| Impacted | | | |
| (Millions) | | | |
| Messages | 8.79% | 20.59% | 6.24% |
| Impacted | | | |
| as % of Mo. | | | |
| Messages | | | |

As will be further understood, embodiments of the current disclosure may provide A2P messaging platforms, e.g., 116 (FIG. 1) operational flexibility to maximize spam reduction, adjust the size of pre-launch watchlists (and/or messages impacted) by scoring individual TFNs and TFN groups, e.g., TFNs within a texting campaign or an A2P customer.

FIG. 18 depicts an example application programming interface (API) 1800 which may be used in the process flow 1700 of FIG. 17. A first API procedure 1810 may provide for retrieval of the risk index for a campaign and take the form of:
getTFNGroupRiski (CampaignlD, List of TFNs) returns (CampaignID, Group Risk Index, RespCode).
   As will be understood, registrar 1724 verifies ownership of the TFNs, assigns an internal ID to the Campaign, and/or returns the risk index for the campaign.
   A second API procedure 1812 may provide for retrieval of a watchlist for the Campaign and take the form of:
getTFNGroupWatchlist (CampaignlD, maxsize) returns (List of High risk TFNs for CampaignlD, RespCoe), where maxsize is the maximum number of high risk TFNs to return for the campaign.
   As will be understood, the registrar 1724 returns high risk TFNs for the CampaignID, where all high risk TFNs for the campaign are returned when maxsize is ‘0’.
   A third API procedure 1814 may provide for requesting an update with respect to high risk TFNs for the campaign and take the form of:
updateTFNRisk (TFN, TFNRiskDelta=0, paramlist) returns (RespCode), where TFNRiskDelta provides for the adjustment to risk based on information such as campaign type or MNO feedback, and where ‘0’ is the default value; and where paramlist contains [SpamCounts, Message Counts, etc.].
   As will be understood, the registrar 1724 updates the risk for the specified TFN using relevant hints, which may be daily, e.g., SpamCount, MessageCount, etc.
   A fourth API procedure 1816 may provide for the retrieval of a list of high risk TFNs and take the form of:
getTFNRisk (List of TFNs) returns (List of High risk TFNs, RespCode).

Embodiments of the current disclosure may also provide for reputation scoring of telecommunications identifiers at the time of provisioning, which may ensure only trusted telecommunications identifiers are text enabled by leveraging neutral, authoritative data for reputational scoring at the telecommunications identifier level. As such, the authoritative registries of some embodiments of the current disclosure may reduce friction and costs of telecommunications identifier approval processes while improving the quality of the assessment.

As disclosed herein, some embodiments of the current disclosure provide for perpetual reputation scoring that builds over time. The authoritative registries of such embodiments may ensure the status of a telecommunications identifier is updated in real-time. As will be further understood, feedback looks may enhance reputational scoring, central analytics, and/or improve spam containment.

Embodiments of the current disclosure may also provide for data, analytics, and/or transparent communication that exceeds and/or otherwise surpasses the economic value of protocols like “Stir/Shaken”. For example, some embodiments of the current disclosure may provide for MNOs to have access to data that reduces false positives so robotexts may be blocked in a more responsible manner.

Embodiments of the current disclosure may also provide for a universal verified sender applied to RCS.

Embodiments of the current disclosure may provide for integration of processes, such a TCR, which may be integrated into the TSS Registry for text enablement.

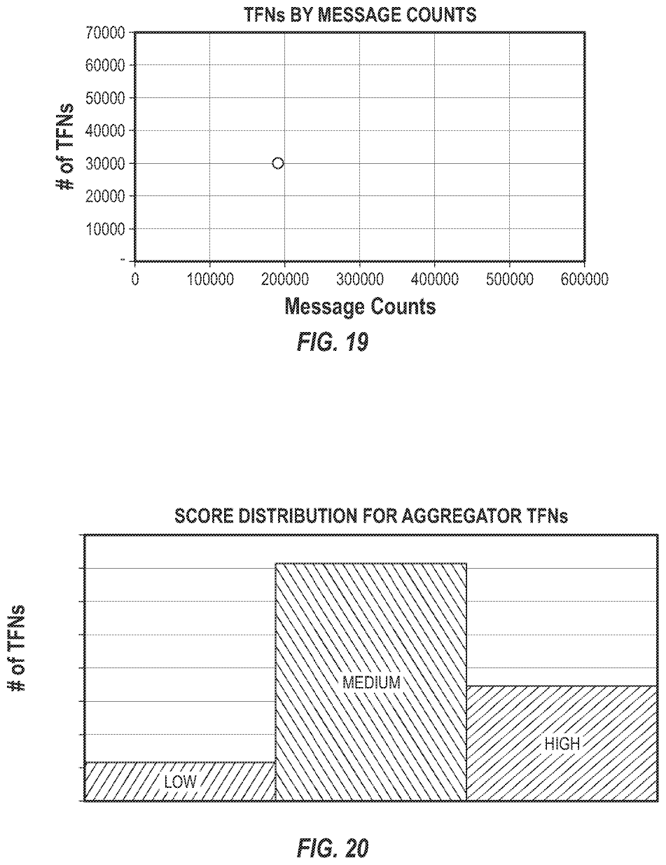

Referring now to tables 3-5 and FIGS. 19-20, results of aggregate TFN experiments, in accordance with embodiments of the current disclosure, are shown. If a TFN was active when initially sampled during the experimental period, the reputation of the corresponding RespOrg was used. If a TFN was inactive when initially sampled during the experimental period, the reputation of the RespOrg that eventually activated the TFN was used. For TFNs that had a text message provisioning entity verified date, it was assumed that these dates were validated by the text message provisioning entity (which could serve as an additional measure of confidence in the TFN). Aggregator customer data (delivery, opt-out, and spam rate) was excluded from the score calculations, but it is to be understood that the opt-out rate could be used as a proxy for interest in a brand. Further, the message counts are depicted herein as overlays with scores for visualization purposes.

TABLE 3

| Status and Ownership | TFNs |
|---|---|
| Inactive | 19,882 |
| Active | 39,806 |
| Total | 59,688 |

TABLE 4
Active TFNs by Ownership

| | |
|---|---|
| Aggregator RespOrg | 21,233 |
| Other (100+) RespOrgs | 18,573 |
| Totals | 39,806 |

TABLE 5
By Ownership

| | |
|---|---|
| Aggregator | 56,415 |
| Other RespOrgs | 3,273 |
| Totals | 59,688 |

As can be seen, 19.8 k TFNs were inactive with 39K TFNs being activated (by 100+RespOrgs). Approximately 3983 TFNs were received out of band during NN onboarding, and 3235 TFNs were not verified by the corresponding Text Messaging Provisioning Entity. About 3273 (˜5%) TFNs were owned by non-aggregator RespOrgs, and nearly 6000 of these TFNs were owned by a single RespOrg. Further, 22% of the TFNs were verified by the corresponding Text Message Provisioning Entity, 44K TFNs had message counts of <500, 15.5 k TFNs had message counts >500, and 67 TFNs had message counts >0.5 M.

Referring to FIG. 20, TNS were scored as either high, medium, or low, where: high TFNs had no significant and/or suspicious traffic, were highly valued within the numbering plan, had stable ownership in the TFN and TSS registries, and did not have reports of fraud; medium TFNs had somewhat clear number histories and/or ownership in the TFN, e.g., little to no suspicious activities, and TSS registries, and did not have reports of fraud; and low TFNs had somewhat unstable and/or inconsistent number history and ownership in the TFN and TSS registries, and narrower application history. Scoring of the TFNs was based on approximately >20 datapoints per TFN combined with knowledge from the relevant RespOrgs. FIG. 20 depicts the distribution of aggregator TFNs by reputation (aggregator label). 41,988 TFNs in use by “Good” customers; 14,518 TFNs were in use by “Bad” customers; and 3,182 TFNs were in use by customers where the aggregator was not in the RespOrg.

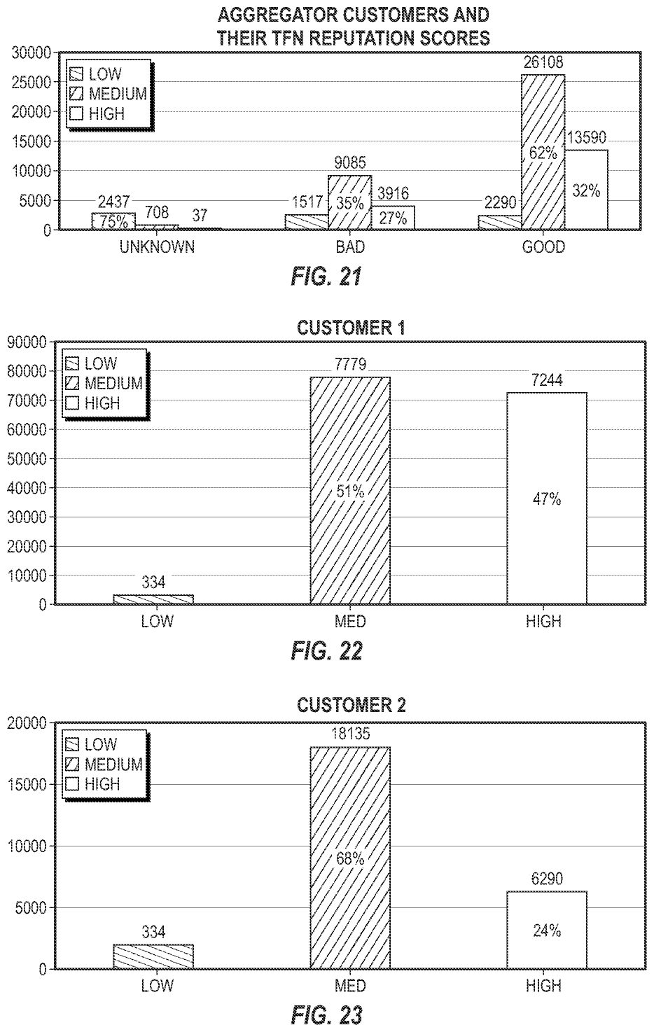

FIG. 21 depicts aggregator customers and their TFN reputation scores. “Good” aggregator customers sent 5 IM messages using 42K TFNs, where ˜94% of the TFNs scored a High or a Medium TFN reputation. “Bad” aggregator customers sent 133 M messages using 14.5K TFNs, where ˜27% of the TFNs scored a high TFN reputation and ˜62% of the TFNs scored medium TFN reputation. “Unknown” aggregator customers sent 27 M messages using 3182 TFNs, where 2437 (˜75%) TFNs received a “Low” TFN reputation score.

FIGS. 22-23 depict “Good” aggregator customers one (1) and two (2), respectively, both of which sored relatively well across all TFN reputation scoring groups. While Customer 1 was found to have “bad actors” on their platform, by and large, their traffic was wanted and had a low percentage of spam and opt-outs. Customer 1 was also found to have sent 500 M messages using 15.3K TFNs. Approximately 97% of Customer l's 15.3K TFNs received medium or high (nearly evenly split) TFN reputation scores. 32 of the TFNs (with 367 M sent messages) scored high. Customer 2 was similar to Customer 1 in that it had some “bad actors”, but these were dealt with quickly so that there was, ultimately, a small percentage of spam and opt-outs. Customer 2 sent 64 M messages using 26.5K TFNs, where about 18K (˜68%) of which scored medium and 6.3K (˜24%) scored high.

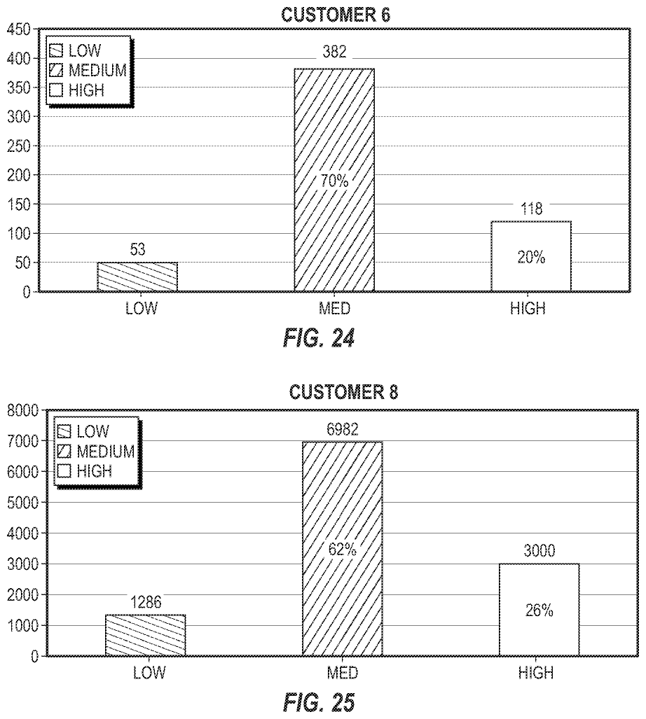

FIGS. 24-25 depict “Bad” aggregator customers six (6) and eight (8), respectively, both of which had sored relatively poor across all TFN reputation scoring groups. Customer 6 used 553 TFNs to send 1.7 M messages, many of which scored below average for attributes 1500 (FIG. 15) falling in the number history grouping, and which also scored nearly average for attributes 1500 (FIG. 15) falling within the RespOrg ownership grouping, e.g., ownership history. 382 (˜70%) of Customer 6's 533 TFNs scored a medium TFN reputation and 118 (˜20%) scored a high TFN reputation. Customer 8 used 11.2K TFNs to send 49.3 M messages, of which many scored below average for attributes 1500 falling within the number history and RespOrg ownership (history) groupings. 7K (˜62%) of Customer 8's 11.2K TFNs scored a medium TFN reputation and about 3K (˜26%) scored a high TFN reputation.

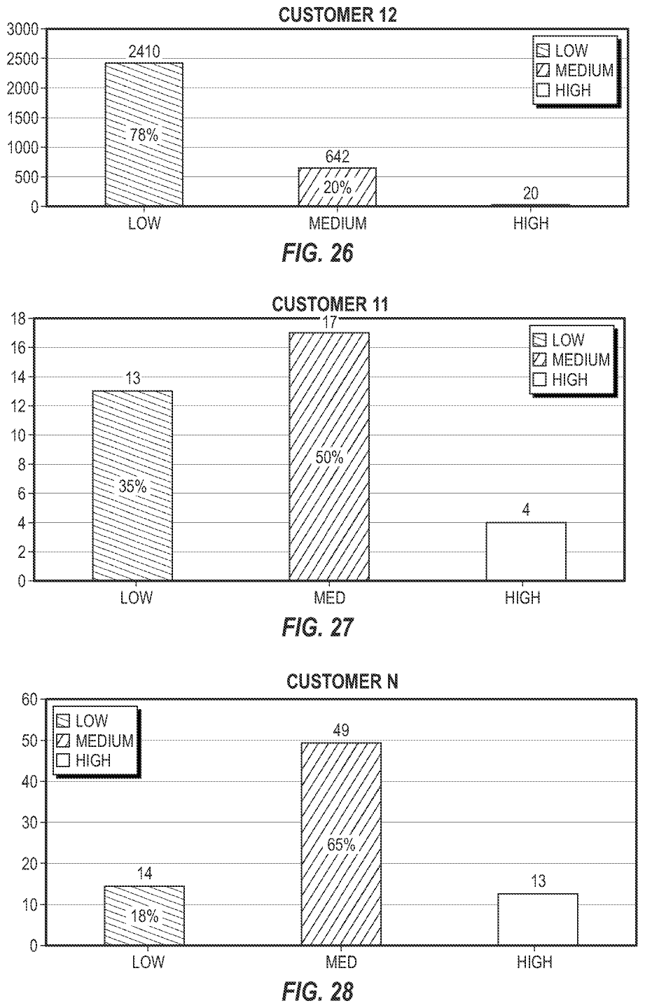

FIG. 26 depicts another “bad” aggregator Customer twelve (12) which used 3072 TFNs to send 26 M messages, where most of the TFNs did not score well across the attribute groupings. In particular, attributes within the RespOrg ownership and TFN number history groupings scored the lowest amongst the aggregator customer cohort. 2410 (˜78%) of Customer 12's TFNs scored as Low, 642 (˜20%) of Customer 12's TFNs scored Medium, and twenty (20) of Customer 12's TFNs scored High.

FIGS. 27 and 28 depict “Unknown” aggregator customers, e.g., Customer eleven (11) and Corporation N, respectively, which, on average, received Medium TFN Reputation scores. 17 (˜50%) of Customer 11's 34 TFNs scored Medium, 13 (˜35%) of Customer 11's 34 TFNs scored Low, and four (4) of Customer 11's TFNs scored High. About 49 (˜65%) of Corporation N's TFNs scored Medium and 14 of Customer N's TFNs scored Low. Although the TFNs for Customers 11 and N scored well in the Number History grouping, the TFNs scored below average in the RespOrg ownership, Brand, and Application groupings.

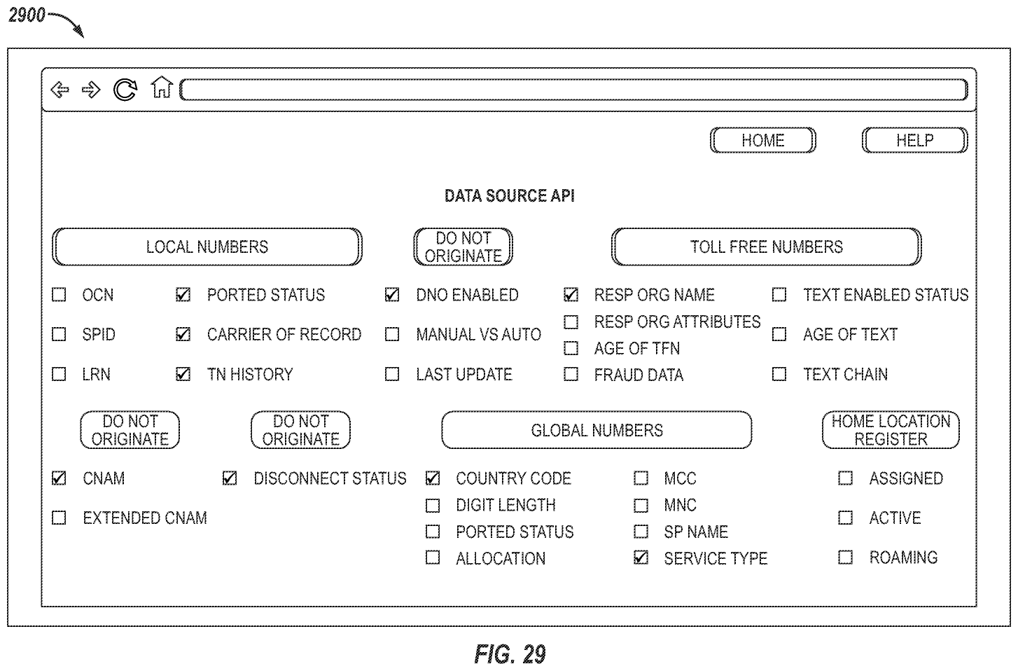

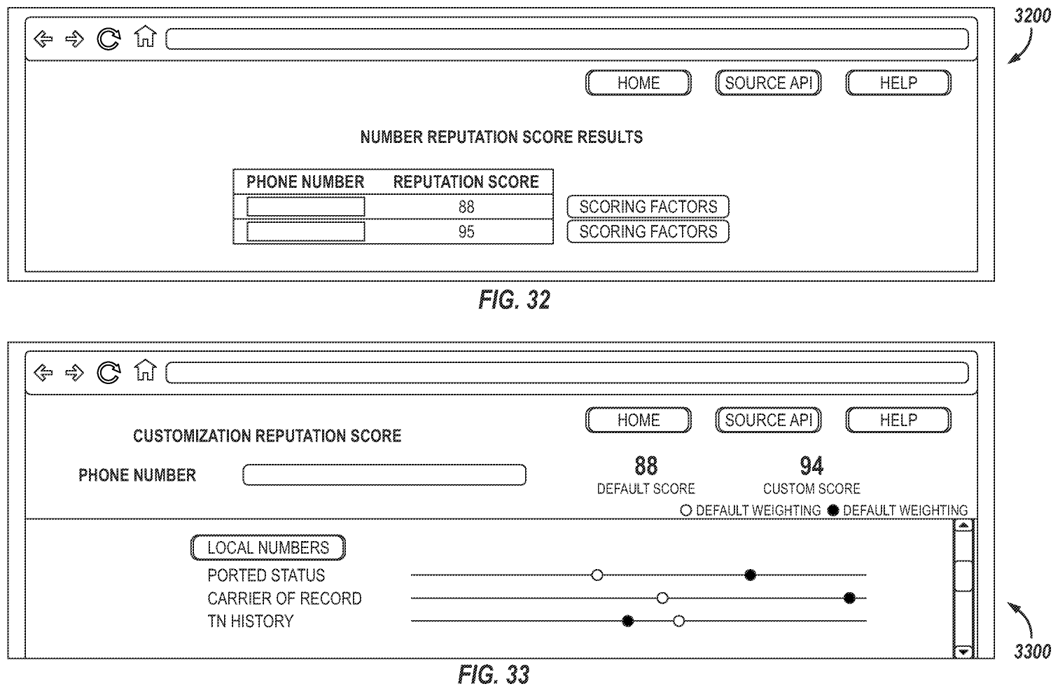

FIGS. 29-33 depict graphical user interfaces (GUIs) for interacting with the server(s) 510 and/or databases 512, 514, and/or 516 (FIG. 5). As shown in FIG. 29, a first GUI 2900 (FIG. 29) may provide for selecting data sources, e.g., TFN 512 and/or TSS 514 (FIG. 5). A second GUI 3000 (FIG. 30) may provide for telecommunications identifier, e.g., phone number, lookup. A third GUI 3100 (FIG. 31) may depict the results of a search conducted via GUI 3000. A fourth GUI 3200 (FIG. 32) may depict reputation scores for one or more telecommunications identifier reputation scores corresponding to search results shown in GUI 3100. A fifth GUI 3300 (FIG. 33) may provide for customization of reputation scores, e.g., adjusting and/or scaling a reputation score to a particular format, e.g., discrete values (high, medium, low) vs more analogue values, e.g., scales of 1-10, 100-1000, −100-0-100, etc. In embodiments, the provided customization may be structured to allow a user to format, scale, and/or otherwise configure a reputation score to suit a particular use case. It will be understood that embodiments of the GUIs disclosed herein may be provided via web user interfaces, desktop applications, mobile device applications, and/or the like.

An example embodiment of the present disclosure, utilizing one or more aspects as set forth preceding, includes an apparatus for assigning reputation scores to telecommunications identifiers. The apparatus includes a first data interpretation circuit, a second data interpretation circuit, a data analysis circuit, a scoring circuit, and a score provisioning circuit. The first data interpretation circuit is structured to interpret first data from a first database, wherein the first data corresponds to at least one telecommunications identifier. The second data interpretation circuit is structured to interpret second data from a second database distinct from the first database, wherein the second data corresponds to the at least one telecommunications identifier. The data analysis circuit is structured to determine, based at least in part on the first data and the second data, one or more attributes for the at least one telecommunications identifier. The scoring circuit is structured to generate, based at least in part on the one or more attributes, a reputation score for the at least one telecommunications identifier. The score provisioning circuit is structure to transmit the reputation score. In certain aspects, the apparatus includes the first database. In certain aspects, the first database includes records associating the at least one telecommunications identifier with an entity. In certain aspects, the first database is a Toll-Free Number Registry. In certain aspects, the first database includes records associating the at least one telecommunications identifier with one or more authorized services. In certain aspects, the first database is a Toll-Free Texting and Smart Services Registry. In certain aspects, the apparatus includes the first database and the second database. In certain aspects, the first database includes records associating the at least one telecommunications identifier with an entity; and the second database includes records associating the at least one telecommunications identifier with one or more authorized services. In certain aspects, the first database is a Toll-Free Number Registry; and the second database is a Toll-Free Texting and Smart Services Registry. In certain aspects, the apparatus further includes a fraud network, wherein the data analysis circuit is further structured to determine the one or more attributes based at least in part on fraud data available via the fraud network.

An example embodiment of the present disclosure, utilizing one or more aspects as set forth preceding, includes a method for assigning scores to telecommunications identifiers. The method includes interpreting, via at least one processor, first data from a first database, the first data corresponding to at least one telecommunications identifier; and interpreting, via the at least one processor, second data from a second database, the second data corresponding to the at least one telecommunications identifier. The method further includes determining, via the at least one processor and based at least in part on the first data and the second data, one or more attributes for the at least one telecommunications identifier; and generating, via the at least one processor and based at least in part on the one or more attributes, a reputation score for the at least one telecommunications identifier. The method further includes transmitting, via the at least one processor, the reputation score. In certain aspects, the method further includes associating the at least one telecommunications identifier with an entity in a database. In certain aspects, the database is a toll-free number registry. In certain aspects, the method further includes operating the Toll-Free Number Registry. In certain aspects, the method further includes associating the at least one telecommunications identifier with one or more authorized service in a database. In certain aspects, the database is a Toll-Free Texting and Smart Services Registry. In certain aspects, the method further includes operating the Toll-Free Texting and Smart Services Registry. In certain aspects, the method further includes associating the at least one telecommunications identifier with an entity in a first database; and associating the at least one telecommunications identifier with one or more authorized service in a second database. In certain aspects, the first database is a Toll-Free Number Registry; and the second database is a Toll-Free Texting and Smart Services Registry. In certain aspects, the method further includes operating the Toll-Free Number Registry; and operating the Toll-Free Texting and Smart Services Registry. In certain aspects, the first database is a Toll-Free Number Registry, and the second database is a Toll-Free Texting and Smart Services Registry; and the method further includes operating the Toll-Free Number Registry, and operating the Toll-Free Texting and Smart Service Registry. In certain aspects, the first database is at least one of an IoT Device Registry, a Network Device Registry, or a Fraud Registry.

An example embodiment of the present disclosure, utilizing one or more aspects as set forth preceding, includes a method that includes interpreting call routing data with a telecommunications identifier; and generating, via at least one processor, a reputation score request command value structured to retrieve a reputation score for a telecommunications identifier. The method further includes transmitting the reputation score request command value to a server; and receiving a reputation score responsive to transmitting the reputation score request command value to the server, the reputation score corresponding to the telecommunications identifier. The method further includes executing an action with respect to the call routing data based at least in part on the reputation score. In certain aspects, the action is routing telecommunications data originating from a source corresponding to the telecommunications identifier. In certain aspects, the telecommunications data forms part of a text message. In certain aspects, the telecommunications data forms part of a call. In certain aspects, the telecommunications data forms part of a graphical message. In certain aspects, the action is dropping telecommunications data originating from a source corresponding to the telecommunications identifier. In certain aspects, the action is reporting the origination of telecommunications data, from a source corresponding to the telecommunications identifier, to a fraud tracking database.

An example embodiment of the present disclosure, utilizing one or more aspects as set forth preceding, includes a method that includes generating, via a campaign requesting circuit, a messaging campaign request that includes a request to execute a messaging campaign; and transmitting, via a campaign request provisioning circuit, the messaging campaign request to an approving authority. The method further includes interpreting, via an approval processing circuit, a campaign approval message from the approving authority; and transmitting, via a campaign circuit and based at least in part on the campaign approval message, a plurality of electronic communications in accordance with the messaging campaign. In certain aspects, the messaging campaign request includes a telecommunications identifier which the plurality of electronic communications will be associated with associated when transmitted. In certain aspects, the telecommunications identifier is a short code. In certain aspects, the telecommunications identifier is a ten-digit code. In certain aspects, the telecommunications identifier is a telecommunications number. In certain aspects, the telecommunications number is a local number. In certain aspects, the telecommunications number is a toll-free number.

An example embodiment of the present disclosure, utilizing one or more aspects as set forth preceding, includes an apparatus that includes a campaign requesting circuit, a campaign request provisioning circuit, an approval processing circuit, and a campaign circuit. The campaign requesting circuit is structured to generate a messaging campaign request that includes a request to execute a messaging campaign. The campaign request provisioning circuit is structured to transmit the messaging campaign request to an approving authority. The approval processing circuit is structured to interpret a campaign message from the approving authority. The campaign circuit is structured to transmit a plurality of electronic communications in accordance with the messaging campaign. In certain aspects, the messaging campaign request includes a telecommunications identifier which the plurality of electronic communications will be associated with associated when transmitted. In certain aspects, the telecommunications identifier is a short code. In certain aspects, the telecommunications identifier is a ten-digit code. In certain aspects, the telecommunications identifier is a telecommunications number. In certain aspects, the telecommunications identifier is a local number. In certain aspects, the telecommunications number is a toll-free number.

An example embodiment of the present disclosure, utilizing one or more aspects as set forth preceding, includes a method for executing a messaging campaign. The method includes generating a plurality of telecommunication messages; and transmitting each of the plurality of telecommunication messages to one of a plurality of telecommunications identifiers each associated with an intended distinct recipient. Each of the plurality of telecommunication messages is associated with a same short code. In certain aspects, the method further includes: interpreting a campaign request from an entity; and determining a reputation score of the entity. Generating the plurality of telecommunication messages is based at least in part on the reputation score. In certain aspects, generating the plurality of telecommunication messages is performed when the reputation score meets or exceeds a threshold. In certain aspects, the threshold corresponds to a level of trust with respect to a propensity to commit fraud. In certain aspects, the reputation score is determined by a registrar and the method further includes: determining feedback data corresponding to the reputation score; and transmitting the feedback data to the registrar. In certain aspects, the feedback data indicates the reputation score needs to be adjusted. In certain aspects, the adjustment is an increase in value. In certain aspects, the adjustment is a decrease in value.

An example embodiment of the present disclosure, utilizing one or more aspects as set forth preceding, includes a method for executing a messaging campaign. The method includes generating a plurality of telecommunication messages; and transmitting each of the plurality of telecommunication messages to one of a plurality of telecommunications identifiers each associated with an intended distinct recipient. Each of the plurality of telecommunication messages is associated with a same ten-digit code. In certain aspects, the method further includes: interpreting a campaign request from an entity; and determining a reputation score of the entity. Generating the plurality of telecommunication messages is based at least in part on the reputation score. In certain aspects, generating the plurality of telecommunication messages is performed when the reputation score meets or exceeds a threshold. In certain aspects, the threshold corresponds to a level of trust with respect to a propensity to commit fraud. In certain aspects, the reputation score is determined by a registrar and the method further includes: determining feedback data corresponding to the reputation score; and transmitting the feedback data to the registrar. In certain aspects, the feedback data indicates the reputation score needs to be adjusted. In certain aspects, the adjustment is an increase in value. In certain aspects, the adjustment is a decrease in value.

An example embodiment of the present disclosure, utilizing one or more aspects as set forth preceding, includes a system including a first database, a second database, and a registrar. The first database stores first data corresponding to at least one telecommunications identifier. The second database stores second data corresponding to the at least one telecommunications identifier. The registrar server is structured to: access and interpret the first data and the second data to determine one or more attributes for the at least one telecommunications identifier; determine a reputation score for the at least one telecommunications identifier; and transmit the reputation score. In certain aspects, the registrar server determines the reputation score based at least in part on weighting the one or more attributes. In certain aspects, the system further includes a third database, and weighing the one or more attributes is based at least in part on third data stored within the third database. In certain aspects, the third data corresponds to at least one management behavior of an entity associated with the at least one telecommunications identifier. In certain aspects, the third data corresponds to at least one transactional behavior of an entity associated with the at least one telecommunications identifier. In certain aspects, the third data corresponds to at least one fraudulent behavior of an entity associated with the at least one telecommunications identifier. In certain aspects, the at least one fraudulent behavior includes number masking. In certain aspects, the at least one fraudulent behavior further includes spoofing. In certain aspects, the at least one fraudulent behavior further includes a negative experience by a user, associated with a mobile device, with the entity.

An example embodiment of the present disclosure, utilizing one or more aspects as set forth preceding, includes a non-transitory computer-readable medium storing instructions. The stored instructions adapt at least one processor to: interpret first data from a first database, the first data corresponding to at least one telecommunications identifier; interpret second data from a second database, the second data corresponding to the at least one telecommunications identifier; determine, based at least in part on the first data and the second data, one or more attributes for the at least one telecommunications identifier; generate, based at least in part on the one or more attributes, a reputation score for the at least one telecommunications identifier; and transmit the reputation score. In certain aspects, the stored instructions further adapt the at least one processor to: associate the at least one telecommunications identifier with an entity based at least in part on the first data. In certain aspects, the first database stores at least one record pairing the at least one telecommunications identifier to the entity. In certain aspects, the at least one telecommunications identifier is a local number. In certain aspects, the at least one telecommunications identifier is an IP address. In certain aspects, the at least one telecommunications identifier is a street address. In certain aspects, the first database is a toll-free number registry. In certain aspects, the stored instructions further adapt the at least one processor to: associate the at least one telecommunications identifier with one or more authorized service. In certain aspects, the first database is a Toll-Free Texting and Smart Services Registry.

As will be appreciated, embodiments of the current disclosure build upon base TFN and TSS historic data by adding TFN reputation attributes, TFN transactional feedback, and/or TFN industry insights, which may then be processed via TFN algorithms to generate a TFN reputational score, which in turn may be aggregated to provide for an anonymized way to evaluate the trustworthiness of a TFN.

An example reputation scoring use case includes assigning trust scores for messaging campaigns, e.g., SMS and/or e-mail messaging campaigns. A campaign messaging platform may register its campaign with a registrar who then provides reputation scores to various entities, e.g., MNOs who operate networks that will be used by the campaign messaging platform to distribute campaign messages. Knowledge of a reputation score for a messaging campaign may improve the ability of the MNOs to distinguish between authorized network traffic and fraudulent network traffic which, in turn, may improve the ability of a messaging campaign platform to reach intended recipients and/or customers. Additionally, the registrar may be able to assist the campaign platform in detecting messaging campaign requests associated with fraudulent entities, e.g., the detection of a fraudulent telecommunications identifier within the message portion of a campaign message.

Another example reputation score use case is providing fresh TFNs within a score range that is suitable for a particular application, e.g., a TFN with a very high reputation score could be used for a Government hotline for Covid. As another example, a RespOrg may acquire a TFN with a mid-level TFN score, that may have recently been returned to a registry, for the purpose of examining residual traffic.

Another example reputation score use case us the prioritization or blocking of telecommunications identifier, with respect to accessing and/or using telecommunication resources. For example, telecommunication numbers with a comparatively high reputation e.g., they are trustworthy, may be treated with preferences by telecommunication network resources, e.g., carriers, over less trustworthy telecommunications identifiers. Additionally, telecommunications identifiers with a comparatively low reputation score may be denied access to telecommunication resources, e.g., a number known to have repeatedly been used to commit fraud may have a reputation score below a pre-defined threshold that results in the telecommunications identifier being unable to originate telecommunications.

Another example reputation score use case is the screening of calls for answering and/or callbacks. For example, in embodiments, the reputation score of a telecommunication number originating a telecommunication may be displayed on a user device, e.g., a smart phone, so that the user of the device can make an informative decision as to whether they should answer the inbound telecommunication and/or call the telecommunications identifier back.

Another example reputation score use case is approving and/or enabling text messages to be generated, routed, and/or received. For example, a campaign platform may use reputation scores, as disclosed herein, to filter telecommunications traffic that is passed to an MNO network so as to reduce the amount of spam (originating from the campaign platform) that hits/enters the MNO network. For example, only telecommunications traffic associated with a reputation score above a threshold level may be allowed to pass from the campaign platform to the MNO network.

In embodiments, a reputational score may be based on one or more of: the stability of a company, e.g., how long has it been around, the stability of a number being registered to a company, how often has the company trying to execute a campaign changed numbers, and/or other attributes which may indicate whether a company is stable or likely to be fraudulent in nature. Reputational scores may be dynamic, e.g., adjusted over time. For example, a company may initially have a bad-moderate reputational score that improves over time as the company demonstrates stability and/or a track-record of non-fraudulent activities. In embodiments, attributes used to determine a reputational score may be retrieved from a telecommunications number registration database. In embodiments, attributes may be retrieved from fraud databases and/or other data sources that track fraudulent and/or potentially fraudulent activities associated with telecommunications numbers and/or companies. In embodiments, attributes for determining a score may include a geographic region, e.g., country, zip code, address, state/province, etc., associated with the telecommunications number and/or the company. In embodiments, attributes for determining a score may include network traffic patterns associated with the telecommunications number and/or the company requesting to launch a campaign.

Another example use case of the APIs, disclosed herein, includes real-time dashboard that provide for monitoring of TF and 10DLC messaging campaigns, sole proprietary uses, spam/fraud filtering statistics, etc.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

Accordingly, as is to be appreciated, embodiments of the current disclosure may enhance telecommunication messaging systems by leveraging neutral and/or authoritative data from registry operations to ensure that only numbers with a high level of trust, e.g., a high reputation score, have text enabled. Such embodiments may quickly reduce friction and/or costs of telecommunications by augmenting current processes, with trust levels building over time. For example, some embodiments of the current disclosure may ensure reputations are current and flag any changes to their status (in one or more registries), thereby mitigating the likelihood of reputational scored becoming stale over time. In embodiments, real-time feedback loops between the various members of a telecommunications system, e.g., 100 (FIG. 1) may be integrated into reputation relevant data sets, e.g., attributes 1500, to enhance reputation scoring, as disclosed herein. As such, certain embodiments of the current disclosure may provide for central analytics and/or improved spam control over time. Such authoritative and/or neutral solutions may exceed “Stir/Shaken” like protocols that rely on self-reporting and/or loosing previously implemented standards. Thus, some embodiments of the current disclosure may provide for the formation of closer loops between entities in a telecommunication ecosystem which, in turn, may further provide for greater transparency, analytics, and/or control with respect to telecommunication resources. Further, some embodiments of the current disclosure may provide a foundation for a verified sender for RCS, which may be done without disrupting current processes.

As will be further appreciated, the reputation scoring of telecommunications identifiers and/or entities, as disclosed herein, may provide for a path, e.g., a solution to mitigating spam and/or other types of fraud, in which only verified, trusted, and/or wanted business messaging application telecommunications traffic is delivered to end users without penalizing good (trustworthy) traffic due to the actions of bad (untrustworthy) traffic. Further, embodiments of the current disclosure may provide for proper P2P exemption support that truly supports one-to-one end user traffic profiles which, in turn, may promote industry growth. Further still, unlike many Stir/Shaken-based protocols, the tools, e.g., GUIs, disclosed herein, may provide for the mitigation of robotexts. Yet further still, the APIs, disclosed herein, may provide dashboards for MNOs to monitor their networks and/or telecommunications traffic in real-time.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. An apparatus for assigning reputation scores to telecommunications identifiers, the apparatus comprising:
a first data interpretation circuit structured to interpret first data from a first database, the first data corresponding to at least one telecommunications identifier;
a second data interpretation circuit structured to interpret second data from a second database distinct from the first database, the second data corresponding to the at least one telecommunications identifier;
a data analysis circuit structured to determine, based at least in part on the first data and the second data, one or more attributes for the at least one telecommunications identifier;
a scoring circuit structured to generate, based at least in part on the one or more attributes, a reputation score for the at least one telecommunications identifier; and
a score provisioning circuit structured to transmit the reputation score.

2. The apparatus of claim 1 further comprising the first database.

3. The apparatus of claim 2, wherein the first database comprises records associating the at least one telecommunications identifier with an entity.

4. The apparatus of claim 3, wherein the first database is a Toll-Free Number Registry.

5. The apparatus of claim 2, wherein the first database comprises records associating the at least one telecommunications identifier with one or more authorized services.

6. The apparatus of claim 5, wherein the first database is a Toll-Free Texting and Smart Services Registry.

7. The apparatus of claim 1 further comprising the first database and the second database.

8. The apparatus of claim 7, wherein:
the first database comprises records associating the at least one telecommunications identifier with an entity; and
the second database comprises records associating the at least one telecommunications identifier with one or more authorized services.

9. The apparatus of claim 7, wherein:
the first database is a Toll-Free Number Registry; and
the second database is a Toll-Free Texting and Smart Services Registry.

10. The apparatus of claim 9 further comprising:
a fraud network, wherein the data analysis circuit is further structured to determine the one or more attributes based at least in part on fraud data available via the fraud network.

11. A method for assigning scores to telecommunications identifiers, the method comprising:
interpreting, via at least one processor, first data from a first database, the first data corresponding to at least one telecommunications identifier;
interpreting, via the at least one processor, second data from a second database, the second data corresponding to the at least one telecommunications identifier;
determining, via the at least one processor and based at least in part on the first data and the second data, one or more attributes for the at least one telecommunications identifier;
generating, via the at least one processor and based at least in part on the one or more attributes, a reputation score for the at least one telecommunications identifier; and
transmitting, via the at least one processor, the reputation score.

12. The method of claim 11 further comprising:
associating the at least one telecommunications identifier with an entity in a database.

13. The method of claim 12, wherein the database is a toll-free number registry.

14. The method of claim 13 further comprising:
operating the Toll-Free Number Registry.

15. The method of claim 11 further comprising:
associating the at least one telecommunications identifier with one or more authorized service in a database.

16. The method of claim 15, wherein the database is a Toll-Free Texting and Smart Services Registry.

17. The method of claim 16 further comprising:
operating the Toll-Free Texting and Smart Services Registry.

18. The method of claim 11, wherein the first database is at least one of an IoT Device Registry, a Network Device Registry, or a Fraud Registry.

19. A non-transitory computer-readable medium storing instructions that adapt at least one processor to:
interpret first data from a first database, the first data corresponding to at least one telecommunications identifier;
interpret second data from a second database, the second data corresponding to the at least one telecommunications identifier;
determine, based at least in part on the first data and the second data, one or more attributes for the at least one telecommunications identifier;
generate, based at least in part on the one or more attributes, a reputation score for the at least one telecommunications identifier; and
transmit the reputation score.

20. The non-transitory computer-readable medium of claim 19, wherein the stored instructions further adapt the at least one processor to:
associate the at least one telecommunications identifier with an entity based at least in part on the first data.
